(19) United States
(12) Patent Application Publication
(10) Pub. No.: US 2024/0255824 A1
(43) Pub. Date: Aug. 1, 2024

(54) Power Allocation for Smart Glass

(71) Applicant: SAGE Electrochromics, Inc., Faribault, MN (US)

(72) Inventor: Bryan D. Greer, Northfield, MN (US)

(73) Assignee: SAGE Electrochromics, Inc., Faribault, MN (US)

(21) Appl. No.: 18/420,579

(22) Filed: Jan. 23, 2024

Related U.S. Application Data
(60) Provisional application No. 63/482,292, filed on Jan. 30, 2023.

(51) Int. Cl. G02F 1/163; H02J 7/00; H02J 7/34

(52) U.S. Cl. CPC G02F 1/163; H02J 7/0063; H02J 7/345

(57) ABSTRACT

A system for power allocation includes a smart glass unit, a data communication cable for transmitting both power and data, a power storage device, and a controller. The controller determines a level of charge of the power storage device, identifies a current tinting level of the smart glass unit, and identifies a directed tinting level for the smart glass unit. The controller also allocates power from at least one of the power communication line or the power storage device and to the smart glass unit to control a level of tint of the smart glass unit based on the level of charge of the power storage device, the current tinting level, and the directed tinting level.

### PRIORITY APPLICATION

This application claims benefit of priority to U.S. Provisional Application Ser. No. 63/482,292, entitled “Power Allocation for Smart Glass,” filed Jan. 30, 2023, and which is hereby incorporated herein by reference in its entirety.

### FIELD OF THE DISCLOSURE

The present disclosure is directed to one or more smart glass units, and more specifically to various approaches for using power over the Ethernet (POE) to provide power to power storage device(s) and/or the one or more smart glass units.

### BACKGROUND

Smart glass may be used to decrease heat transfer through a window and/or reduce the transmission of visible light to provide tinting or shading. A smart glass system including a smart glass (e.g., an electrochromic (EC) device, an electrochromic insulated glass unit (EC-IGU), a device with a glass that changes, for example tint, in response to an input, an electrical charge, and/or the environment) may be used to provide a decrease in solar heat gain (e.g., increase in insulation) through a transparent substrate and a reduction in visible light transmission through a transparent substrate (e.g., a window or glass pane). An EC device may include EC materials that are known to change their optical properties, such as coloration, in response to the application of an electrical potential, thereby making the transparent substrate more or less transparent or more or less reflective. An EC device can also change its optical properties such as optical transmission, absorption, reflectance and/or emittance in a continual but reversible manner on application of voltage. These properties enable the EC device to be used for applications like smart glasses, EC mirrors, EC display devices, and the like. EC glass may include a type of glass or glazing for which light transmission properties of the glass or glazing are altered when electrical power (e.g., voltage/current) is applied to the glass. EC materials may change in opacity (e.g., may changes levels of tinting) when electrical power is applied. Installation of smart glass systems may have high installation costs due to the large amount or number of wires needed for operation.

### SUMMARY

A system for power allocation having one or more smart glass units is provided. The system includes the one or more smart glass units. The system also includes a data communication cable for transmitting power and data. In some aspects, the data communication cable may include a data communication line for transmitting data and a power communication line for transmitting power. The system further includes a power storage device. In addition, the system includes a controller. The controller is configured to determine a level of charge of the power storage device. The controller is also configured to identify a current tinting level of at least one smart glass unit of the one or more smart glass units. The controller is further configured to identify a directed tinting level for the at least one smart glass unit of the one or more smart glass units. In addition, the controller is configured to allocate power from at least one of the power communication line or the power storage device and to the at least one smart glass unit of the one or more smart glass units to control a level of tint of the at least one smart glass unit. In some aspects, the controller allocates power from at least one of the power communication line or the power storage device based on the level of charge of the power storage device, the current tinting level of the least one smart glass unit, and the directed tinting level for the at least one smart glass unit.

### BRIEF DESCRIPTION OF THE DRAWINGS

FIG. 1 illustrates a perspective view of an example EC system according to some aspects of this disclosure.

FIG. 2 illustrates a block diagram of an example system according to some aspects of this disclosure.

FIG. 3 illustrates a block diagram of an example system according to some aspects of this disclosure.

FIG. 4 illustrates a block diagram of an example system according to some aspects of this disclosure.

FIG. 5 illustrates a block diagram of an example method according to some aspects of this disclosure.

FIG. 6 illustrates a block diagram of an example method according to some aspects of this disclosure.

FIG. 7 illustrates a block diagram of an example method according to some aspects of this disclosure.

FIG. 8 illustrates a block diagram of an example method according to some aspects of this disclosure.

FIG. 9 illustrates a block diagram of an example method according to some aspects of this disclosure.

FIG. 10 illustrates a block diagram of an example method according to some aspects of this disclosure.

FIG. 11 illustrates a block diagram of an example method according to some aspects of this disclosure.

FIG. 12 illustrates a block diagram of an example method according to some aspects of this disclosure.

FIG. 13 illustrates a block diagram of an example method according to some aspects of this disclosure.

FIG. 14 illustrates a block diagram of an example method according to some aspects of this disclosure.

FIG. 15 illustrates a block diagram of an example method according to some aspects of this disclosure.

FIG. 16 illustrates a block diagram of an example method according to some aspects of this disclosure.

FIG. 17 illustrates a block diagram of an example method according to some aspects of this disclosure.

FIG. 18 illustrates an example computer system that may be used in some embodiments.

This specification may include references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value. It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will further be understood that the term “or” as used herein refers to and encompasses alternative combinations as well as any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. For example, the words “include,” “including,” and “includes” indicate open-ended relationships and therefore mean including, but not limited to. Similarly, the words “have,” “having,” and “has” also indicate open-ended relationships, and thus mean having, but not limited to.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Whenever a relative term, such as “about”, “substantially” or “approximately”, is used in this specification, such a term should also be construed to also include the exact term. That is, e.g., “substantially straight” should be construed to also include “(exactly) straight”. As used herein, the terms “about”, “substantially”, or “approximately” (and other relative terms) may be interpreted in light of the specification and/or by those having ordinary skill in the art. In some examples, such terms may as much as 1%, 3%, 5%, 7%, or 10% different from the respective exact term.

While embodiments are described herein by way of example for several embodiments and illustrative drawings, those skilled in the art will recognize that the embodiments are not limited to the embodiments or drawings described. It should be understood that the drawings and detailed description thereto are not intended to limit embodiments to the particular form disclosed, but on the contrary, the intention is to cover all modifications, equivalents and alternatives falling within the spirit and scope as defined by the appended claims. Any headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must).

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION

Systems for allocating power for a smart glass are described herein. Smart glass may be used to decrease heat transfer through a window and/or reduce the transmission of visible light to provide tinting or shading. A smart glass system including a smart glass (e.g., an electrochromic (EC) device, an electrochromic insulated glass unit (EC-IGU), a device with a glass that changes, for example tint, in response to an input, an electrical charge, and/or the environment) may be used to provide a decrease in solar heat gain (e.g., increase in insulation) through a transparent substrate and a reduction in visible light transmission through a transparent substrate (e.g., a window or glass pane). An EC device may include EC materials that are known to change their optical properties, such as coloration, in response to the application of an electrical potential, thereby making the transparent substrate more or less transparent or more or less reflective. An EC device can also change its optical properties such as optical transmission, absorption, reflectance and/or emittance in a continual but reversible manner on application of voltage. These properties enable the EC device to be used for applications like smart glasses, EC mirrors, EC display devices, and the like. EC glass may include a type of glass or glazing for which light transmission properties of the glass or glazing are altered when electrical power (e.g., voltage/current) is applied to the glass. EC materials may change in opacity (e.g., may changes levels of tinting) when electrical power is applied.

In some cases, installing wiring for providing power to the smart glass may require expensive electricians to run wiring for alternating current (AC) power to the smart glass system(s). As such, smart glass systems may utilize low-voltage power over a power communication line that, for example, is included as part of a data communication cable (e.g., an Ethernet cable) that also includes a data communication line. Using a power communication line of a data communication cable to supply power to the smart glass may allow network installers to install smart glass equipment without having to bring an electrician to run AC power to the smart glass equipment.

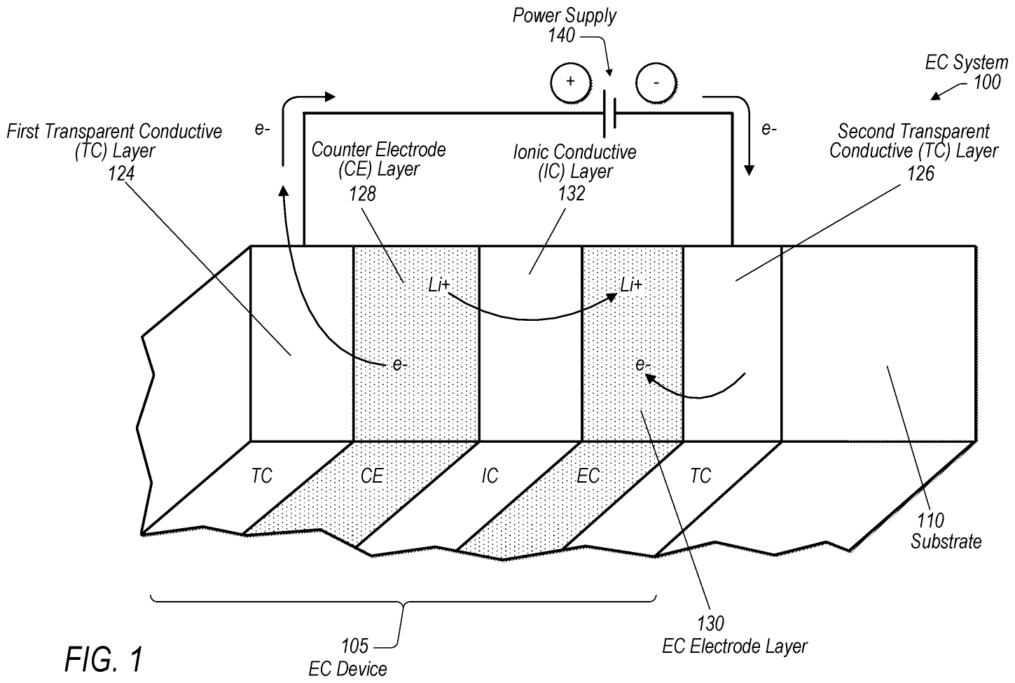

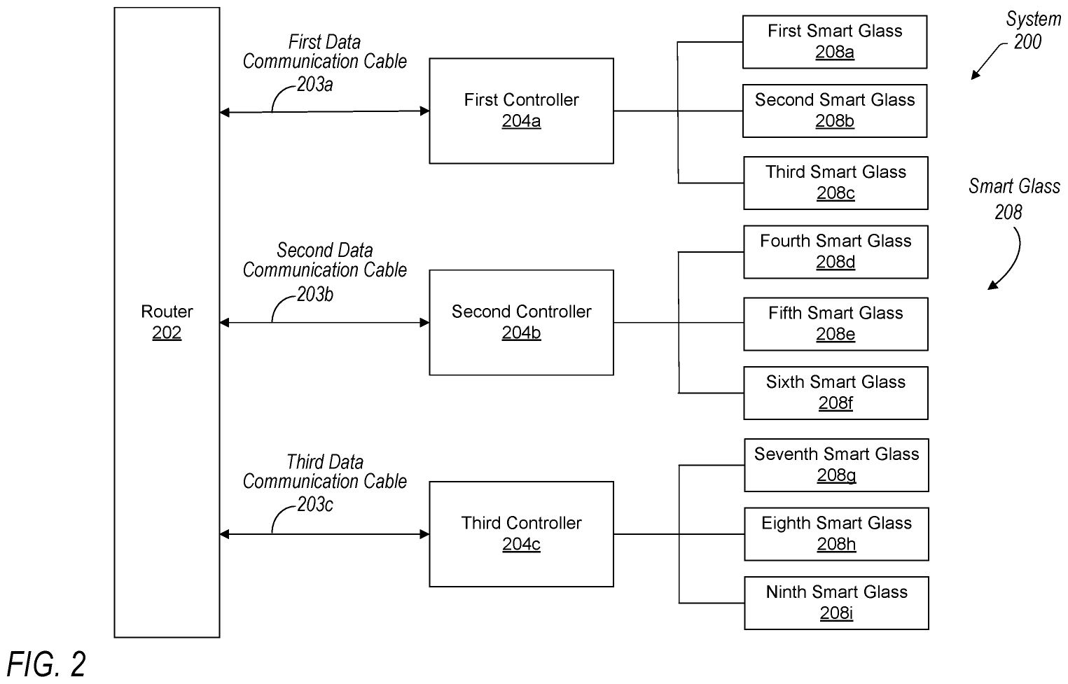

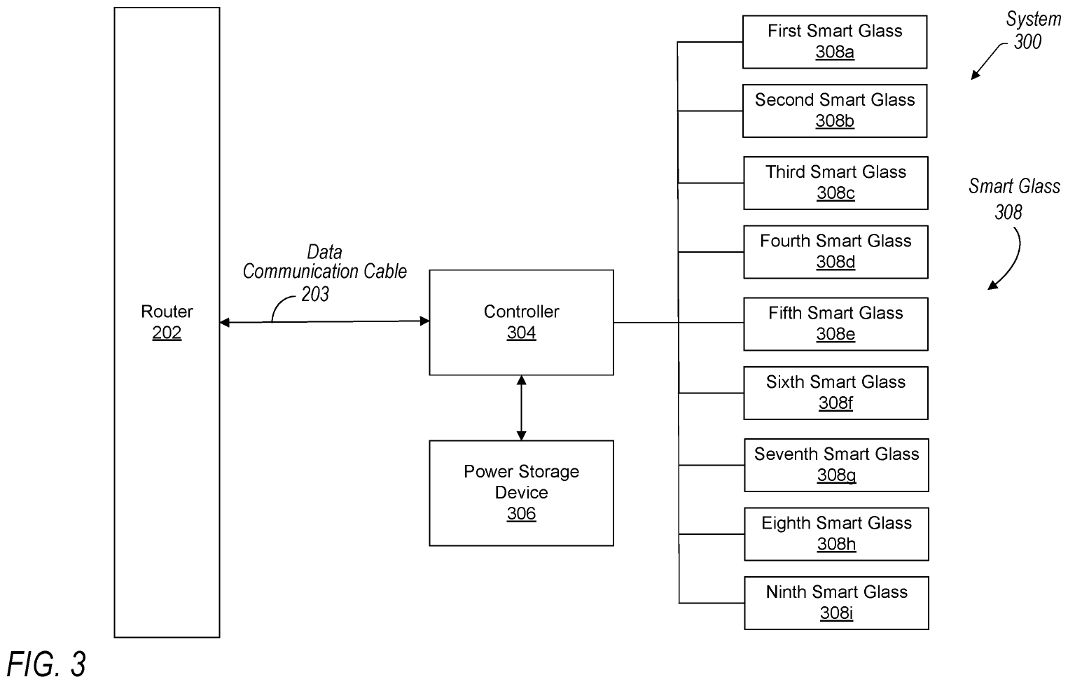

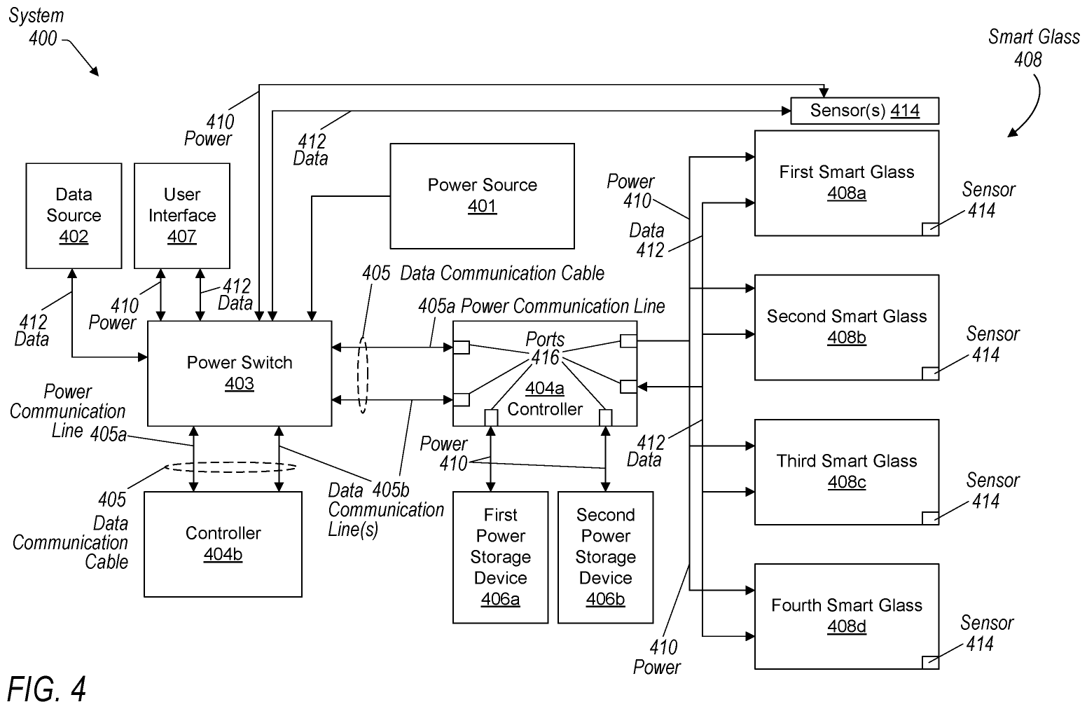

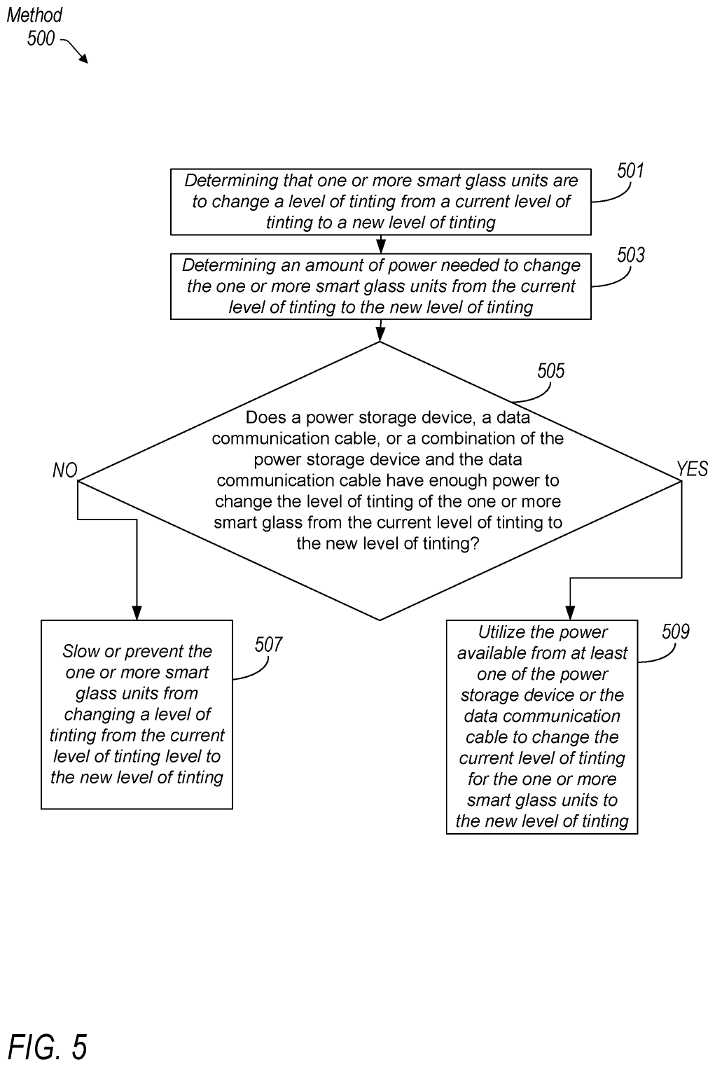

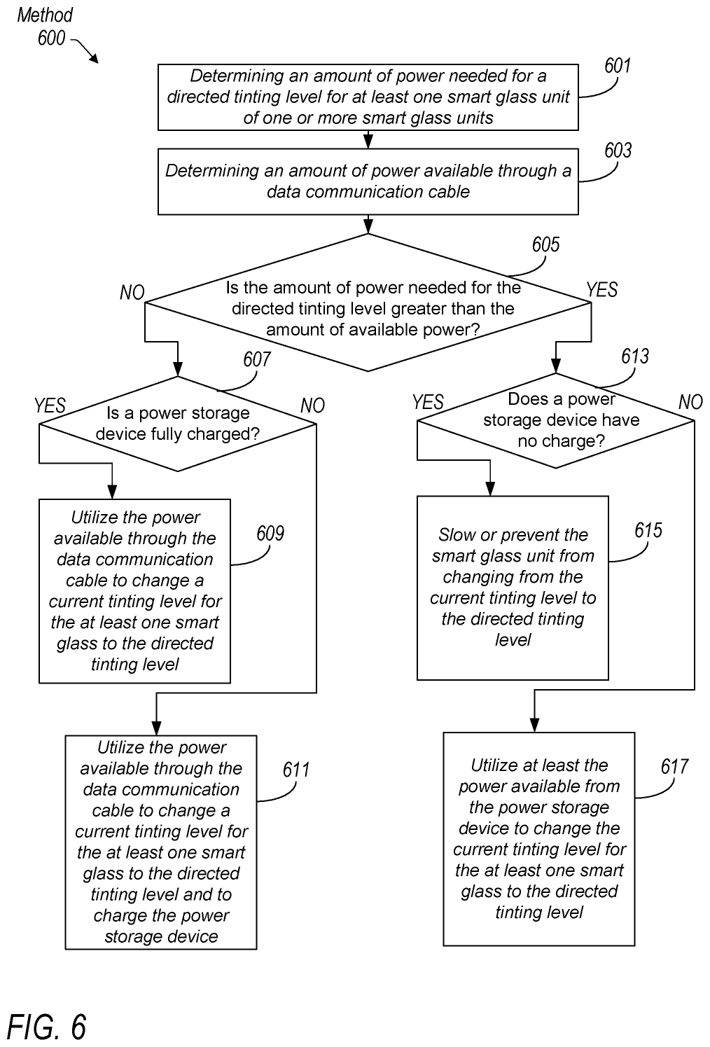

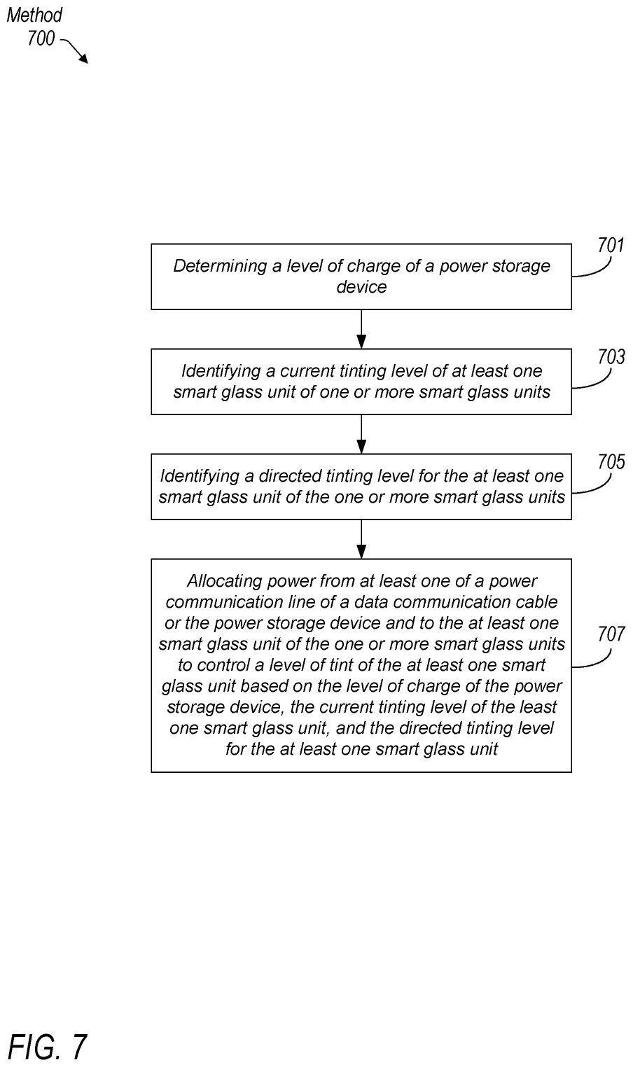

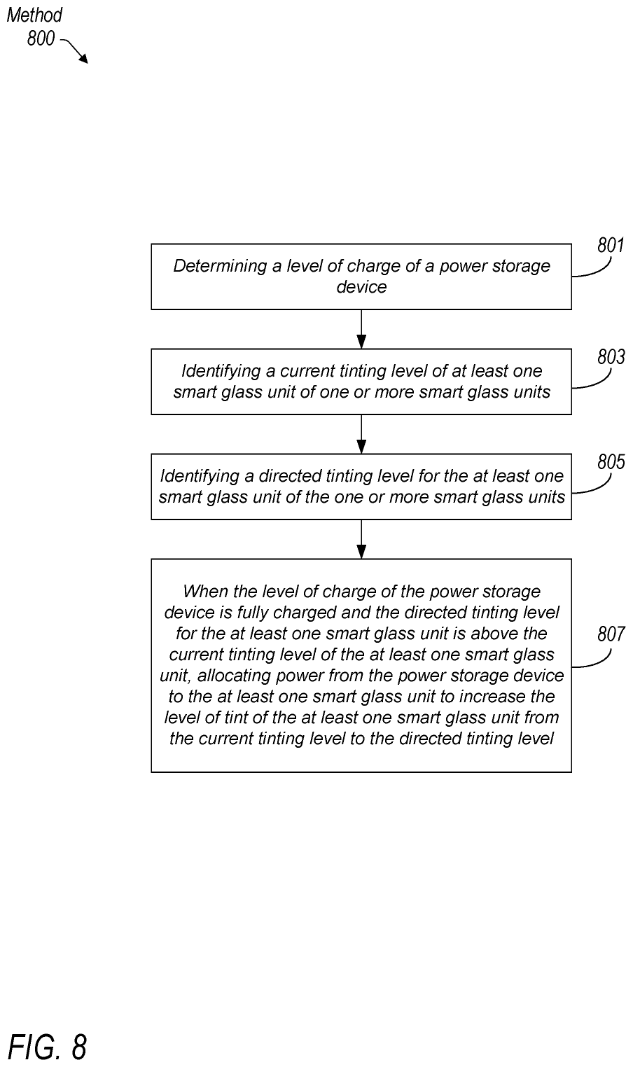

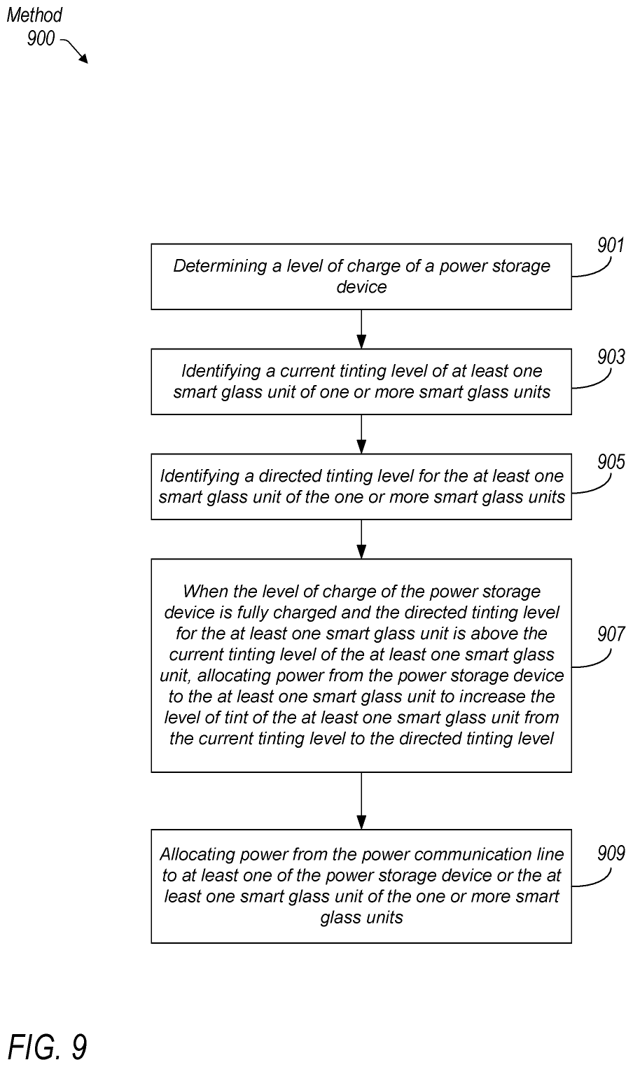

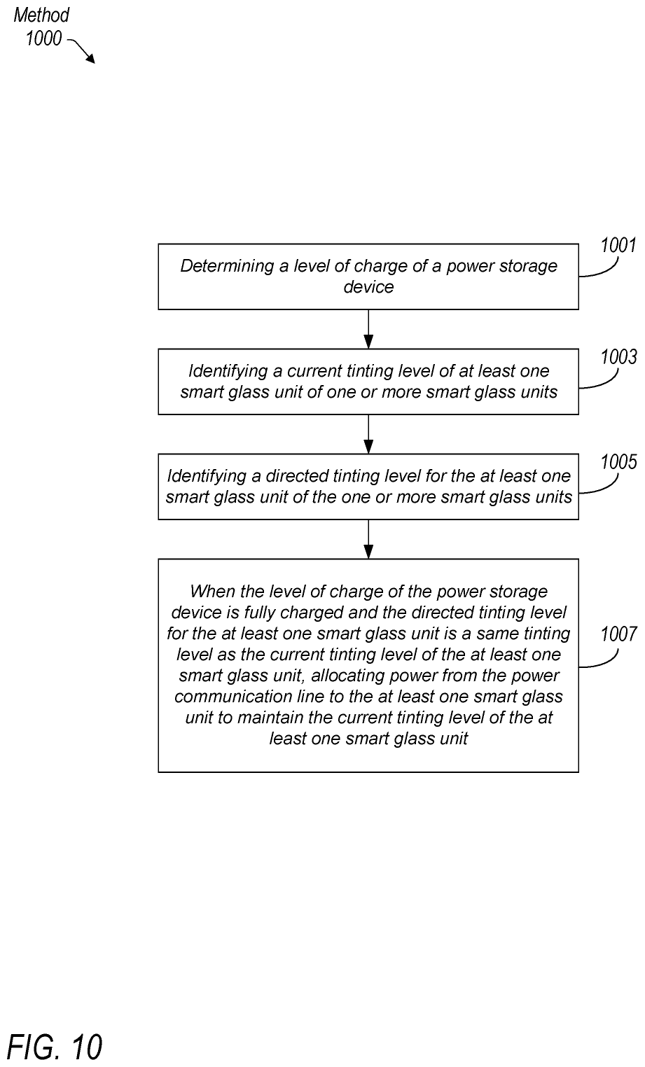

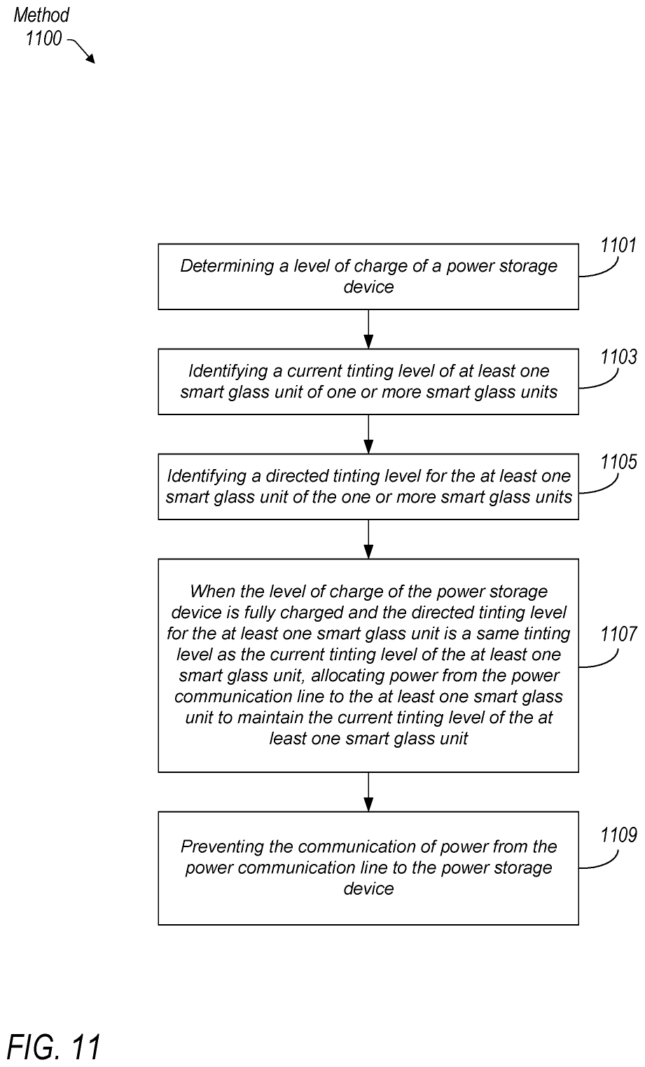

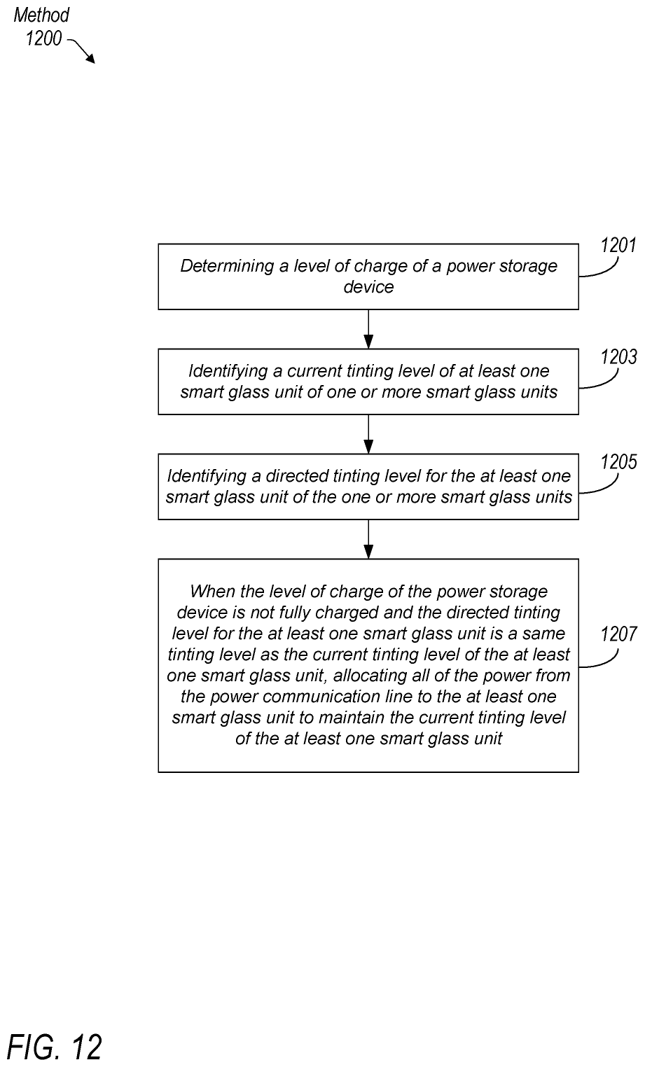

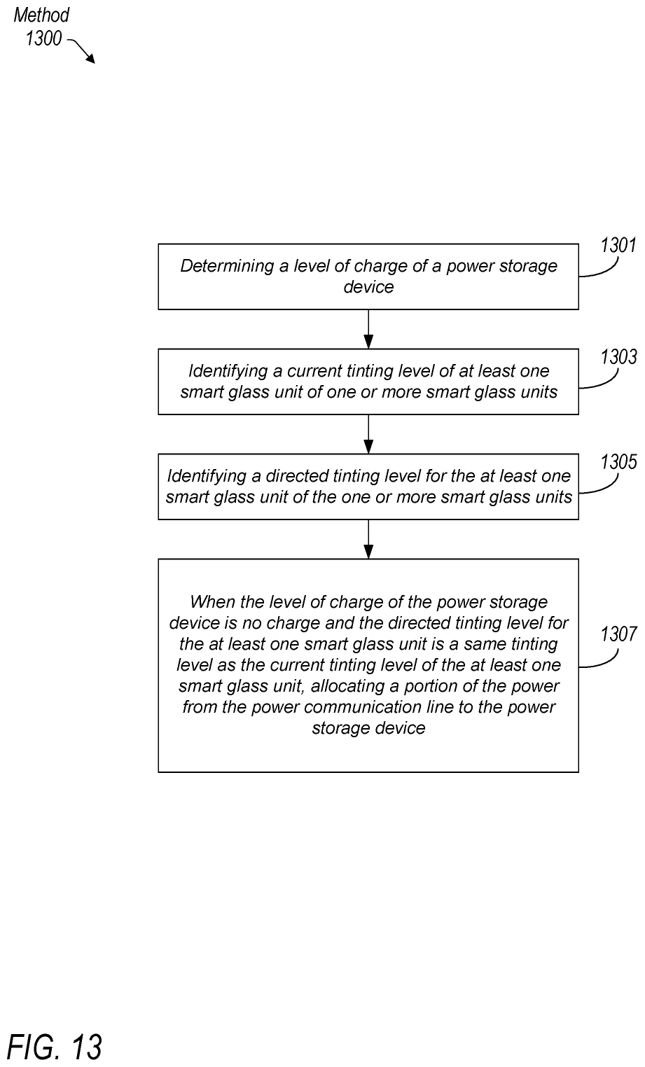

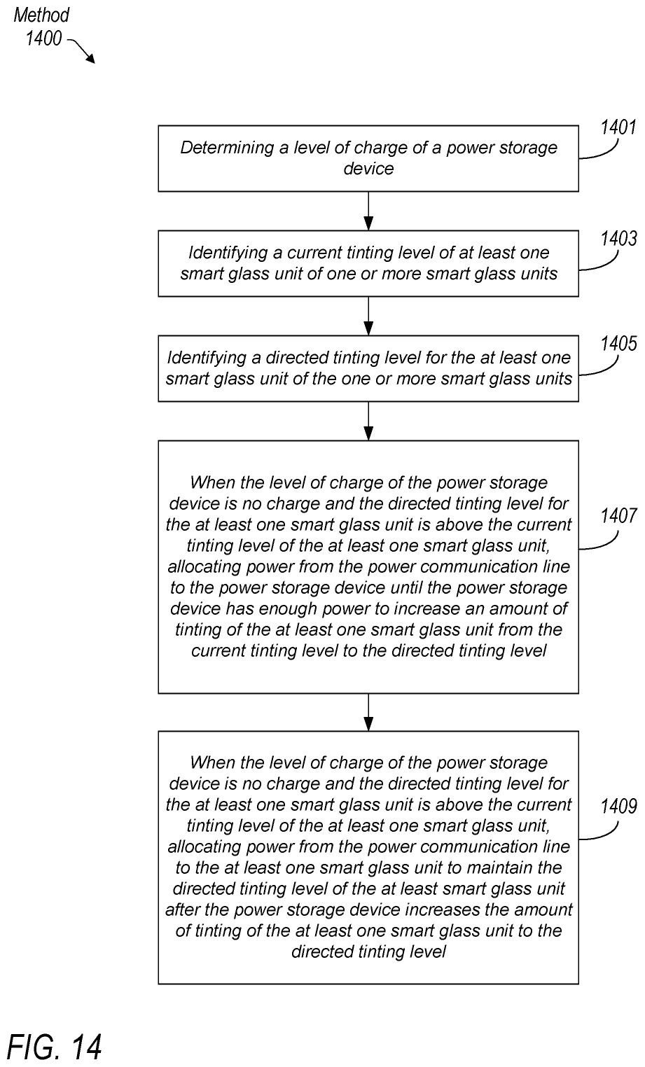

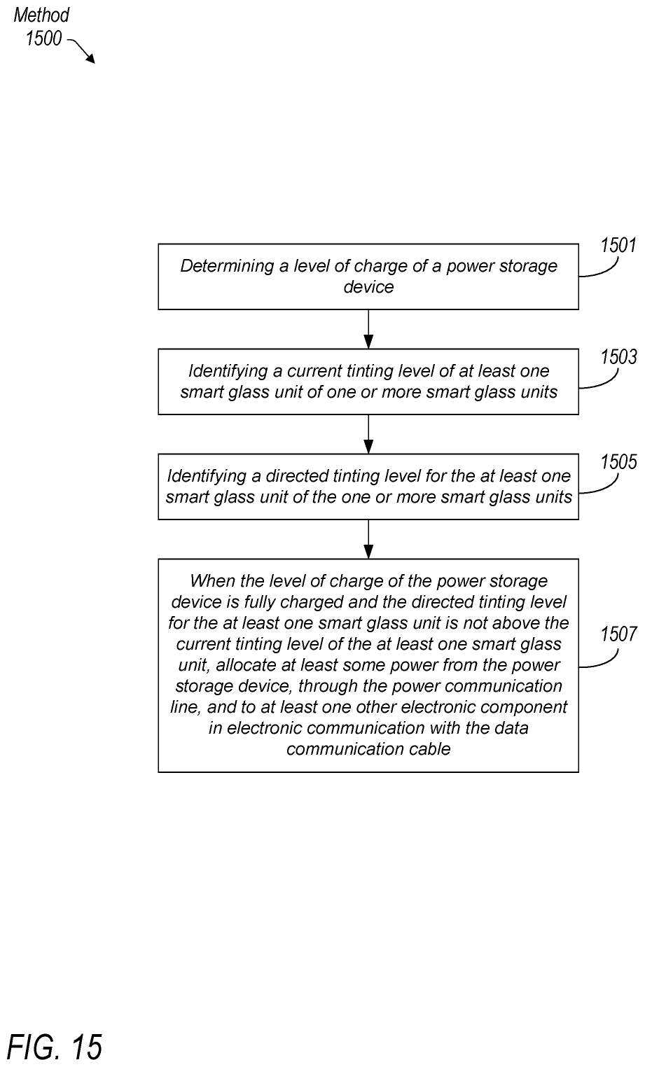

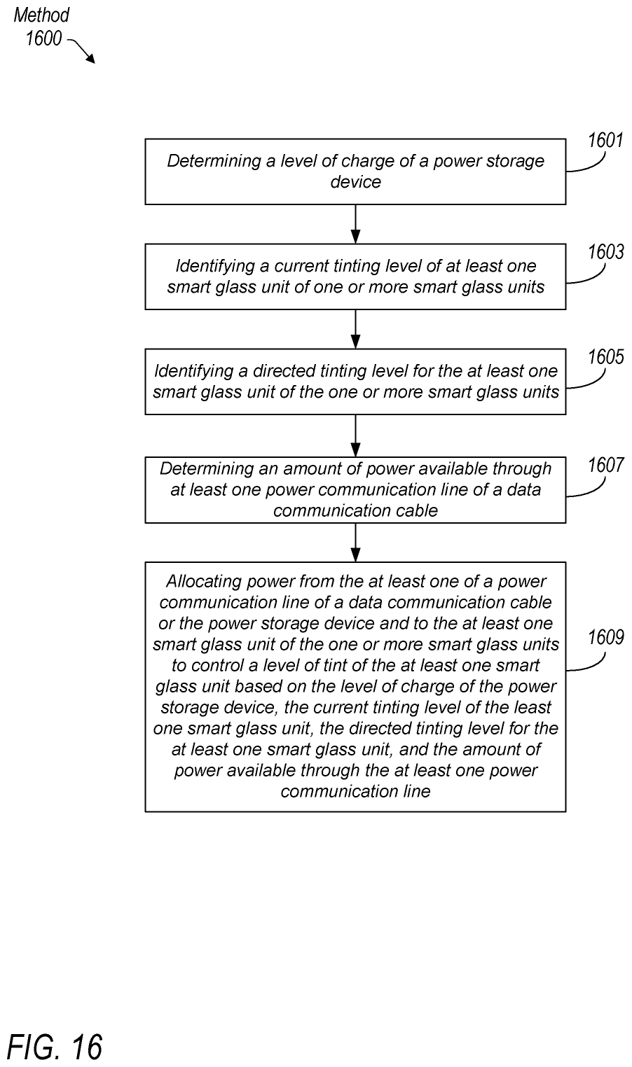

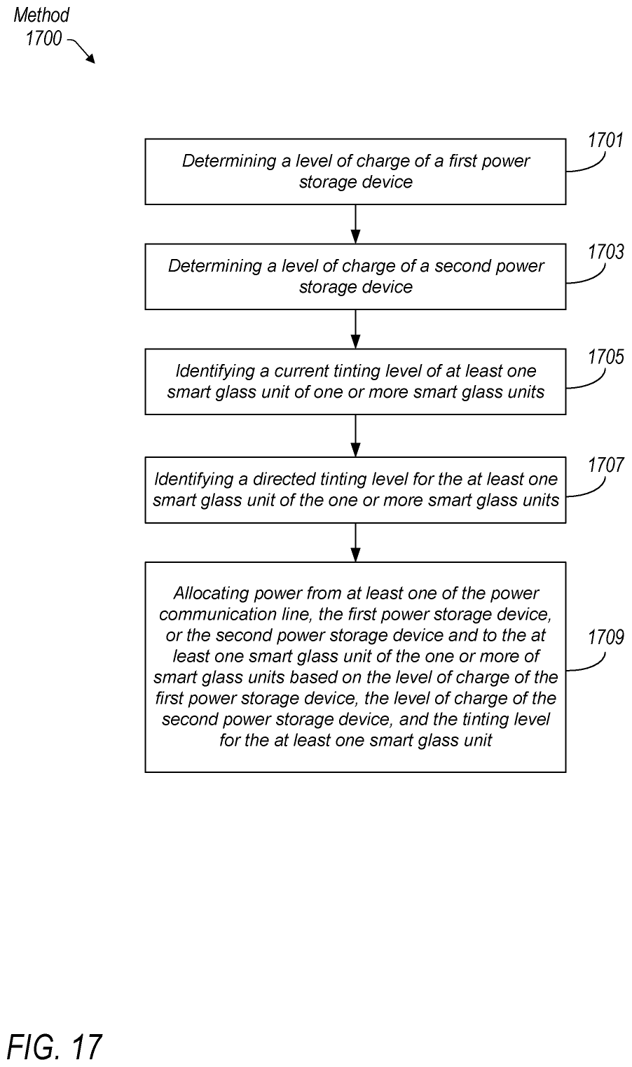

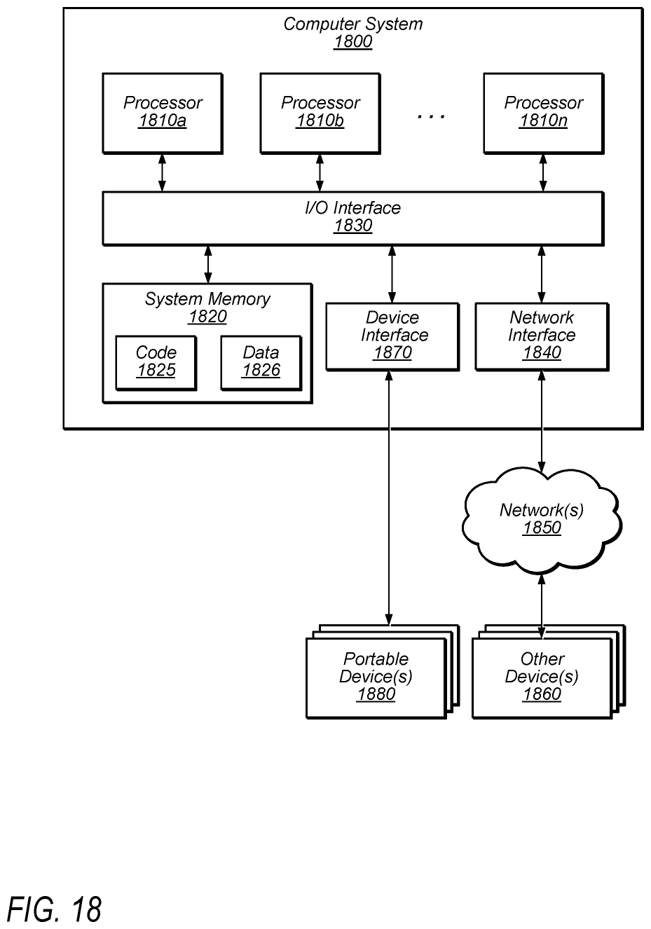

FIG. 1 illustrates a perspective view of an example EC system 100 according to some aspects of this disclosure. The EC system 100 may include one or more same or similar features as the features described with respect to or illustrated in FIGS. 2, 3, 4, 5, 6, 7, 8, 9, 10, 11, 12, 13, 14, 15, 16, 17, and 18. For example, the EC system 100 may include one or more same or similar features as the system 200 illustrated in FIG. 2, the system 300 illustrated in FIG. 3, the system 400 illustrated in FIG. 4, and/or the computer system 1800 illustrated in FIG. 18. The EC system 100 may implement one or more same or similar steps or procedures as provided in the method 500 described with respect to FIG. 5, the method 600 described with respect to FIG. 6, the method 700 described with respect to FIG. 7, the method 800 described with respect to FIG. 8, the method 900 describe with respect to FIG. 9, the method 1000 described with respect to FIG. 10, the method 1100 described with respect to FIG. 11, the method 1200 described with respect to FIG. 12, the method 1300 described with respect to FIG. 13, the method 1400 described with respect to FIG. 14, the method 1500 described with respect to FIG. 15, the method 1600 described with respect to FIG. 16, and/or the method 1700 described with respect to FIG. 17. FIG. 1, as with the other included figures, is shown for illustrative purposes and does not limit either the possible embodiments of the present invention or the claims.

In this example, the EC system 100 may include an EC device 105 secured to a substrate 110. The EC device 105 may be a non-limiting an example of a smart glass or smart glass unit as provided herein. The EC device 105 may include a thin film which may be deposited on to the substrate 110. The EC device 105 may include a first transparent conductive (TC) layer 124 and a second TC layer 126 in contact with the substrate 110. In some aspects, the first TC layer 124 and the second TC layer 126 may be, or may include, one or more transparent conductive oxide (TCO) layers. The substrate 110 may include one or more optically transparent materials, e.g., glass, plastic, and the like. The EC device 105 may also include a counter electrode (CE) layer 128 in contact with the first TC layer 124, an EC electrode layer 130 in contact with the second TC layer 126, and ionic conductor (IC) layer 132 in-between (e.g., “sandwiched” between) the CE layer 128 and the EC electrode layer 130. The EC system 100 may include a power supply 140 which may provide regulated current or voltage to the EC device 105. Transparency of the EC device 105 may be controlled by regulating density of charges (or lithium ions) in the CE layer 128 and/or the EC electrode layer 130 of the EC device 105. For instance, when the EC system 100 applies a positive voltage from the power supply 140 to the first TC layer 124, lithium ions may be driven across the IC layer 132 and inserted into the EC electrode layer 130. Simultaneously, charge-compensating electrons may be extracted from the CE layer 128, may flow across the external circuit, and may flow into the EC electrode layer 130. Transfer of lithium ions and associated electrons from the CE layer 128 to the EC electrode layer 130 may cause the EC device 105 to become darker—e.g., the visible light transmission of the EC device 105 may decrease. Reversing the voltage polarity may cause the lithium ions and associated charges to return to their original layer, the CE layer 128, and as a result, the EC device 105 may return to a clear state—e.g., the visible light transmission of the EC device 105 may increase.

As described herein, a smart glass or device such as the EC device 105 of FIG. 1 may receive a charge (e.g., a voltage) for controlling a tint of the smart glass. For example, an electrical charge may be provided to a smart glass to increase a level of tint (e.g., darken) of the smart glass. As another example, an electrical charge may be provided to a smart glass to maintain a level of tint of the smart glass. As yet another example, an electrical charge may be provided to a smart glass to decrease a level of tint of the smart glass. As another example, an electrical charge may be provided to a smart glass to clear a tint of the smart glass.

FIG. 2 illustrates a block diagram of an example system 200 according to some aspects of this disclosure. The system 200 may include one or more same or similar features as the features described with respect to or illustrated in FIGS. 1, 3, 4, 5, 6, 7, 8, 9, 10, 11, 12, 13, 14, 15, 16, 17, and 18. For example, the system 200 may include one or more same or similar features as the EC system 100 illustrated in FIG. 1, the system 300 illustrated in FIG. 3, the system 400 illustrated in FIG. 4, and/or the computer system 1800 illustrated in FIG. 18. The system 200 may implement one or more same or similar steps or procedures as provided in the method 500 described with respect to FIG. 5, the method 600 described with respect to FIG. 6, the method 700 described with respect to FIG. 7, the method 800 described with respect to FIG. 8, the method 900 describe with respect to FIG. 9, the method 1000 described with respect to FIG. 10, the method 1100 described with respect to FIG. 11, the method 1200 described with respect to FIG. 12, the method 1300 described with respect to FIG. 13, the method 1400 described with respect to FIG. 14, the method 1500 described with respect to FIG. 15, the method 1600 described with respect to FIG. 16, and/or the method 1700 described with respect to FIG. 17. FIG. 2, as with the other included figures, is shown for illustrative purposes and does not limit either the possible embodiments of the present invention or the claims.

As shown in FIG. 2, the system 200 includes a router 202, a first controller 204a, a second controller 204b, a third controller 204c, and a plurality of smart glass 208 (e.g., a plurality of smart glass units). The plurality of smart glass 208 may include a first smart glass 208a, a second smart glass 208b, a third smart glass 208c, a fourth smart glass 208d, a fifth smart glass 208c, a sixth smart glass 208f, a seventh smart glass 208g, an eighth smart glass 208h, and a ninth smart glass 208i. The router 202 may be compatible with a PoE+ standard for providing power over a power communication line of a data communication cable (e.g., an Ethernet cable) to a controller to power smart glass. For example, the router 202 may be compatible with a PoE+ standard for providing about 26.0 watts (W) of power per powered controller to power the smart glass. For example, as shown in FIG. 2, the router 202 may provide electrical power to the first controller 204a over a first data communication cable 203a, to the second controller 204b over a second data communication cable 203b, and to the third controller 204b over a third data communication cable 204c. Electrical power provided over a power communication line of a data communication cable may include limited power or relatively low power. Additionally, or alternatively, other similar limited-power and/or relatively low power sources or providers may be used in the systems described herein to power smart glass. Generally, relatively larger smart glass units may need about 5.0 W or more to perform a tint switch (e.g., increase a level of tint, decrease a level of tint, or clear a tint). In some cases, with long wire runs, smart glass units may need more than 10.0 W to perform a tint switch. However, smart glass units may need much less power to maintain a level of tint. Thus, the average power needed for a smart glass unit over a period of time may be much less than the peak power needed during a tint switch or tint transition. The system 200 including the router 200 utilizing the PoE+ standard providing about 26.0 W of power per controller may be capable of both maintaining a level of tint and performing a tint switch due to only as many as three (3) smart glass units per controller. However, the system 200 including the router 202 utilizing the PoE+ standard may necessitate a large number of controllers, network cables, routers, and connections to power a multitude of smart glass units due to the power limits set by the standard. For example, using the router 202 implementing PoE+ standard, the first controller 204a may only provide enough power to both perform tint switching and to maintain a tint of as many as the first smart glass 208a, the second smart glass 208b, and the third smart glass 208c; the second controller 204b may only provide enough power to both perform tint switching and to maintain a tint of as many as the fourth smart glass 208d, the fifth smart glass 208e, and the sixth smart glass 208f; and the third controller 204c may only provide enough power to both perform tint switching and to maintain a tint of as many as the seventh smart glass 208g, the eighth smart glass 208h, and the ninth smart glass 208i. In some cases, a router utilizing PoE++ Type 4 providing for 71 W per powered controller may provide enough power to both perform tint switching and to maintain a tint of as many as six (6) smart glass units per controller but may still require many routers and connections for operating a multitude of smart glass units.

It should be understood, the routers utilizing a plurality of different standards may also be limited by their respective standards in a same or similar way as described with respect to the system 200. For example, for large smart glass with long wires and using 12 W for peak power and 3 W for average power: PoE standard uses about 12.95 W per channel and is limited to one (1) smart glass unit per controller; PoE+ standard uses about 25.5 W per channel and is limited to two (2) smart glass units per controller; PoE++ Type 3 uses about 51 W per channel and is limited to four (4) smart glass units per controller; and PoE++ Type 4 uses about 71.3 W per channel and is limited to six (6) smart glass units per controller. As another example, for HARMONY™ smart glass with long wires and using 9 W for peak power and 2.5 W for average power: PoE standard uses about 12.95 W per channel and is limited to one (1) smart glass unit per controller; PoE+ standard uses about 25.5 W per channel and is limited to two (2) smart glass units per controller; PoE++ Type 3 uses about 51 W per channel and is limited to five (5) smart glass units per controller; and PoE++ Type 4 uses about 71.3 W per channel and is limited to eight (8) smart glass units per controller.

In some aspects, a system may include one or more power storage devices (e.g., a battery, a super capacitor) that are in electrical communication with one or more controllers. As described below, the system 300 of FIG. 3 may include one or more power storage devices that are in electrical communication with one or more controllers. The addition of one or more power storage devices may increase the number of smart glass units per controller for at least each of the aforementioned standards while providing enough power to both perform tint switching and to maintain a tint for each smart glass unit of the increased number of smart glass units. For example, with the addition of one or more power storage devices and for large smart glass with long wires and using 12 W for peak power and 3 W for average power: PoE standard uses about 12.95 W per channel and may include as many as four (4) smart glass units per controller (e.g., rather than one (1) smart glass unit per controller without a power storage device as described herein); PoE+ standard uses about 25.5 W per channel and may include as many as eight (8) smart glass units per controller (e.g., rather than two (2) smart glass units per controller without a power storage device as described herein); PoE++ Type 3 uses about 51 W per channel and may include as many as seventeen (17) smart glass units per controller (e.g., rather than four (4) smart glass units per controller without a power storage device as described herein); and PoE++ Type 4 uses about 71.3 W per channel and may include as many as twenty-four (24) smart glass units per controller (e.g., rather than six (6) smart glass units per controller without a power storage device as described herein). As another example, with the addition of one or more power storage devices and for HARMONY™ smart glass with long wires and using 9 W for peak power and 2.5 W for average power: PoE standard uses about 12.95 W per channel and may include as many as five (5) smart glass units per controller (e.g., rather than one (1) smart glass unit per controller without a power storage device as described herein); PoE+ standard uses about 25.5 W per channel and may include as many as ten (10) smart glass units per controller (e.g., rather than two (2) smart glass units per controller without a power storage device as described herein); PoE++ Type 3 uses about 51 W per channel and may include as many as twenty (20) smart glass units per controller (e.g., rather than five (5) smart glass units per controller without a power storage device as described herein); and PoE++ Type 4 uses about 71.3 W per channel and may include as many as twenty-eight (28) smart glass units per controller (e.g., rather than eight (8) smart glass units per controller without a power storage device as described herein).

Generally, as described herein, smart glass units may need a lot of power to perform a tint switch (e.g., increase a level of tint, decrease a level of tint, or clear a tint) and less power to maintain a level of tint. Thus, the average power needed for a smart glass unit over a period of time may be less or much less than the peak power needed during a tint switch or tint transition. As such, a system (such as the system 300 of FIG. 3 described herein) may utilize the power storage device capable of providing the peak power needed to perform a tint switch of one or more smart glass of the plurality of smart glass units and use power from the router to provide power to maintain a level of tint of one or more smart glass before or after a tint switch is performed. While the system may use power to maintain the level of tint of the one or more smart glass, the system may also utilize power (e.g., excess power) to charge or recharge the power storage device. For example, a controller may allocate some PoE from the router to the smart glass units to maintain a level of tint of the smart glass units while allocating a remainder amount of power from the router to the power storage device to charge the power storage device. Subsequently, when one or more smart glass units need a tint switch, the controller may allocate power from the power storage device to the one or more smart glass units to perform the tint switch. Afterwards, the controller may again allocate some power from the router to the smart glass units to maintain a level of tint of the smart glass units while allocating a remainder amount of power from the router to the power storage device to recharge the power storage device. The power storage device may be capable of holding enough energy or power (e.g., electrical power) to perform multiple tint switches before recharging. For this type of limited direct current (DC) source, the power storage device may significantly reduce the number of wires, the number of routers, and/or the total available power needed. In some aspects, as described further herein, a system may include multiple power storage devices (e.g., a second power storage device) providing greater functionality as well as redundancy.

FIG. 3 illustrates a block diagram of an example system 300 according to some aspects of this disclosure. The system 300 may include one or more same or similar features as the features described with respect to or illustrated in FIGS. 1, 2, 4, 5, 6, 7, 8, 9, 10, 11, 12, 13, 14, 15, 16, 17, and 18. For example, the system 300 may include one or more same or similar features as the EC system 100 illustrated in FIG. 1, the system 200 illustrated in FIG. 2, the system 400 illustrated in FIG. 4, and/or the computer system 1800 illustrated in FIG. 18. The system 300 may implement one or more same or similar steps or procedures as provided in the method 500 described with respect to FIG. 5, the method 600 described with respect to FIG. 6, the method 700 described with respect to FIG. 7, the method 800 described with respect to FIG. 8, the method 900 describe with respect to FIG. 9, the method 1000 described with respect to FIG. 10, the method 1100 described with respect to FIG. 11, the method 1200 described with respect to FIG. 12, the method 1300 described with respect to FIG. 13, the method 1400 described with respect to FIG. 14, the method 1500 described with respect to FIG. 15, the method 1600 described with respect to FIG. 16, and/or the method 1700 described with respect to FIG. 17. FIG. 3, as with the other included figures, is shown for illustrative purposes and does not limit either the possible embodiments of the present invention or the claims.

As shown in FIG. 3, the system 300 includes the router 202 and a plurality of smart glass 308 (e.g., a plurality of smart glass units). The plurality of smart glass 308 may include a first smart glass 308a, a second smart glass 308b, a third smart glass 308c, a fourth smart glass 308d, a fifth smart glass 308c, a sixth smart glass 308f, a seventh smart glass 308g, an eighth smart glass 308h, and a ninth smart glass 308i. The system 300 also includes a controller 304 and a power storage device 306. The controller 304 (e.g., a single controller) may be electrically connected (e.g., directly connected) to each of the plurality of smart glass 308 and may control the distribution of power to each of the plurality of smart glass units 308 for performing tint switching and/or for maintaining a tint for each of the smart glass units. The power storage device 306 (e.g., a battery, a super-capacitor) may be electrically connected directly to the controller 304 and may be electrically connected to the plurality of smart glass 308 and the router 202 via the controller 304. In some aspects, the power storage device 306 may be embedded within the controller 304. The addition of the power storage device 306 may provide the plurality of smart glass units 308 with additional power for performing a tint switch of one or more smart glass units while the system 300 continues to use PoE or other low-power sources or limited-power sources (e.g., single-pair PoE (SPoE), Power over Data Line (PoDL), UPOE, LTPoE++, or the like) to maintain a tint of one or more other smart glass units. Thus, the addition of one or more power storage devices may allow for an increase in the number of smart glass units per controller for at least each of the aforementioned standards while providing enough power to both perform tint switching and to maintain a tint for each smart glass unit of the increased number of smart glass units. As such, the system 300 may implement one controller (e.g., the controller 304) to electrically connect the router 202 to all or each of the first smart glass 308a, the second smart glass 308b, the third smart glass 308c, the fourth smart glass 308d, the fifth smart glass 308e, the sixth smart glass 308f, the seventh smart glass 308g, the eighth smart glass 308h, and the ninth smart glass 308i.

FIG. 4 illustrates a block diagram of an example system 400 according to some aspects of this disclosure. The system 400 may include one or more same or similar features as the features described with respect to or illustrated in FIGS. 1, 2, 3, 5, 6, 7, 8, 9, 10, 11, 12, 13, 14, 15, 16, 17, and 18. For example, the system 400 may include one or more same or similar features as the EC system 100 illustrated in FIG. 1, the system 200 illustrated in FIG. 2, the system 300 illustrated in FIG. 3, and/or the computer system 1800 illustrated in FIG. 18. The system 400 may implement one or more same or similar steps or procedures as provided in the method 500 described with respect to FIG. 5, the method 600 described with respect to FIG. 6, the method 700 described with respect to FIG. 7, the method 800 described with respect to FIG. 8, the method 900 describe with respect to FIG. 9, the method 1000 described with respect to FIG. 10, the method 1100 described with respect to FIG. 11, the method 1200 described with respect to FIG. 12, the method 1300 described with respect to FIG. 13, the method 1400 described with respect to FIG. 14, the method 1500 described with respect to FIG. 15, the method 1600 described with respect to FIG. 16, and/or the method 1700 described with respect to FIG. 17. FIG. 4, as with the other included figures, is shown for illustrative purposes and does not limit either the possible embodiments of the present invention or the claims.

As shown in FIG. 4, the system 400 includes a power source 401 (e.g., a low-power source, a limited power source, power for PoE), a data source 402, a power switch 403, a first controller 404a, a second controller 404b, a data communication cable 405 (e.g., an Ethernet cable) having a power communication line 405a and a data communication line 405b, a first power storage device 406a, a second power storage device 406b, a user interface 407, and a plurality of smart glass 408. For example, the plurality of smart glass 408 may include a first smart glass 408a, a second smart glass 408b, a third smart glass 408c, and a fourth smart glass 408d. As shown herein, the power switch 403 may be configured to communicate data 412 (e.g., a directed level of tint for respective smart glass, a current level of tint of respective smart glass, an amount of power available through the data communication line 405b) between one or more data sources (e.g., a network system, central controller, building automation system, personal computer, handheld electronic device, or the like) and to the controllers 404a and 404b. Similarly, the power switch 403 may be configured to communicate data 412 (e.g., a directed level of tint for respective smart glass, a current level of tint of respective smart glass, an amount of power available through the data communication line 405b) between the user interface (e.g., a personal computer, display screen, mobile electronic device, a handheld electronic device, or the like) and to the controllers 404a and 404b. In some aspect, the power switch 403 may be configured to communication data 412 from one or more sensors 414. In some aspect, the controllers (e.g., the first controller 404a) may be configured to receive data 412 from one or more sensor 414 attached to and/or embedded with respective smart glass units 408. The data 412 from the sensors 414 may indicate a level of light received or near the smart glass units 408. In some aspects, the controllers (e.g., the first controller 404a) may be configured to provide power (from PoE) via the power switch 403 to one or more sensors 414 and/or the user interface 407. The power source 401 (e.g., a power source, a low-power source, a limited-power source) may be configured to provide power 410 (e.g., power for PoE, low-power, limited-power) to the power switch 403. The power switch 403 may be electrically connected to one or more data communication cables 405 (e.g., one or more Ethernet cables) for communicating data 412 and power 410 with one or more controllers. The controllers (e.g., the first controller 404a, the second controller 404b) may include ports 416 for receiving and/or transmitting power 410 and data 412 as described herein. In some aspects, the data communication cable 405 may include one or more electrical lines each for transmitting both power and data. In some aspects, the data communication cable 405 may include one or more electrical lines dedicated for transmitting data and/or one or more electrical lines dedicated for transmitting power. For example, the power switch 403 may send and/or receive power 410 through a power communication line 405a of the data communication cable 405 with the first controller 404a for the first controller 404a to provide power to one or more of the smart glass 408 and may send and/or receive data 412 through a data communication line 405b of the data communication cable 405 with the first controller 404a for the first controller 404a to control power to one or more of the smart glass 408. Similarly, the power switch 403 may send and/or receive power 410 through another power communication line 405a of another data communication cable 405 with the second controller 404b for the second controller 404b to provide power to one or more other electronic devices (not shown) (e.g., one or more other smart glass) within the system 400 and may send and/or receive data 412 through another data communication line 405b of the other data communication cable 405 with the second controller 404b for the second controller 404b to control power to the one or more other electronic devices within the system 100. The data 412 received by the respective controllers may be used by the respective controllers to indicate whether one or more particular smart glass units of the smart glass units 408 are to change a level of tint or maintain a level of tint. The power 410 received by the respective controllers from the power communication line 405a may be used to maintain a level of tint of one or more smart glass units of the smart glass units 408 and/or may be stored in the first power storage device 406a (and/or the second power storage device 406b) for subsequent use by a smart glass unit to perform tint switching. In some aspects, the power 410 received by the respective controllers from the power communication line 405a may be used in combination with power 412 stored in the first power storage device 406a (and/or the second power storage device 406b) for tint switching of one or more smart glass units. In some aspects, the controller 404a may receive data 412 (e.g., a current level of tint, an amount of light received by one or more light sensors of a respective smart glass unit, or the like) and use the data 412 to allocate power 410 as described herein. In some aspects, data 412 and power 410 may be distributed to the smart glass units 408 via yet another data communication cable 405 (e.g., an Ethernet cable) having yet another power communication line 405a and yet another data communication line 405b. In some aspects, the first controller 404a may be configured to monitor and report (e.g., to a network system, central controller, building automation system, personal computer, handheld electronic device, or the like) on the health of the first power storage device 406a and the second power storage device 406b to ensure preventative maintenance and/or replacement, for example, when the power storage device has fallen in capacity over a period of time compared to its initial capacity when it was new. In addition, it should be understood that, in some aspects, individual power and/or data lines may be provided between the controllers and each of the smart glass units. Additionally, or alternatively, one or more smart glass units may include individual controllers such that the individual controllers may be daisy-chained together to communicate data and power.

As described herein, the first controller 404a may be configured to allocate power 410 from at least one of the power communication line 405a or the first power storage device 406a (and/or the second power storage device 406b) and to at least one smart glass unit of the smart glass units 408 to control a level of tint of the at least one smart glass unit. For example, the first controller 404a may be configured to receive power 410 from power communication line 405a and store the power 410 from the power communication line 405a in the power storage device 406. As another example, the first controller 404a may be configured to receive power 410 from the power communication line 405a and provide the power 410 to one or more smart glass units of the smart glass units 408 to maintain a level of tint. As yet another example, the first controller 404a may be configured to receive power 410 from the power communication line 405a and receive power 410 from the first power storage device 406a (and/or the second power storage device 406b) and provide the power 410 to one or more smart glass units of the smart glass units 408 to perform tint switching and/or to maintain a level of tint. As another example, the first controller 404a may be configured to receive power 410 from the first power storage device 406a and use that power 410 to perform tint switching of one or more smart glass units of the smart glass units 408.

In some aspects, the first controller 404a may be configured to allocate power 410 from at least one of the power communication line 405a or the first power storage device 406a (and/or the second power storage device 406b) and to at least one smart glass unit of the smart glass units 408 to control a level of tint of the at least one smart glass unit based on one or more determined data parameters. For instance, the first controller 404a may determine (e.g., receive an indication of) a level of charge of the first power storage device 406a (and/or the second power storage device 406b), identify (e.g., a receive an indication of) a current tinting level of first smart glass unit 408a of the smart glass units 408, and identify (e.g., a receive an indication of) a directed tinting level for the first smart glass unit 408a. The first controller 404a may determine a current tinting level of the first smart glass unit 408a from one or more data sources (e.g., a network system, central controller, building automation system, personal computer, handheld electronic device, or the like). The first controller 404a may also determine a directed tinting level of the first smart glass unit 408a using one or more sensors (e.g., light sensors mounted on or near the first smart glass unit 408a) and/or from one or more data sources (e.g., a network system, central controller, building automation system, personal computer, handheld electronic device, or the like) indicating a received directed input or a tinting schedule for the first smart glass unit 408a.

Based on the level of charge of the first power storage device 406a (and/or the second power storage device 406b), the current tinting level of the first smart glass unit 408a, and the directed tinting level for the first smart glass unit 408, the first controller 404a may allocate power from at least one of the power communication line 405a or the first power storage device 406a (and/or the second power storage device 406b) and to the first smart glass unit 408a to control a level of tint of the first smart glass unit 408a. For example, the first controller 404a may determine that the level of charge of the first power storage device 406a (and/or the second power storage device 406b) is fully charged. The first controller 404a may also determine a current tinting level of the first smart glass unit 408a and receive a directed tinting level for the first smart glass unit 408a. The first controller 404a may determine that the directed tinting level for the first smart glass unit 408a is above (e.g., greater than, darker than) a current tint level of the first smart glass unit 408a. Based on determining the first power storage device 406a (and/or the second power storage device 406b) is fully charged and determining that the directed tinting level for the first smart glass unit 408a is above a current tint level of the first smart glass unit 408a, the first controller 404a may allocate power from the first power storage device 406a (and/or the second power storage device 406b) to the first smart glass unit 408a to increase the level of tint of the first smart glass unit 408a from the current tinting level to the directed tinting level. The first controller 404a may determine to allocate power from the first power storage device 406a instead of from the power communication line 405a due to the greater amount of power needed to perform tint switching.

As another example, the first controller 404a may determine that the level of charge of the first power storage device 406a (and/or the second power storage device 406b) is fully charged. The first controller 404a may also determine a current tinting level of the first smart glass unit 408a and receive a directed tinting level for the first smart glass unit 408a. The first controller 404a may determine that the directed tinting level for the first smart glass unit 408a is the same tinting level as the current tint level of the first smart glass unit 408a. Based on determining the first power storage device 406a (and/or the second power storage device 406b) is fully charged and determining that the directed tinting level for the first smart glass unit 408a is the same as the current tint level of the first smart glass unit 408a, the first controller 404a may allocate power from the power communication line 405a of the data communication cable 405 to the first smart glass unit 408a to maintain the current level of tint of the first smart glass unit 408a. The first controller 404a may determine to allocate power from the power communication line 405a instead of the first power storage device 406a due to the lesser amount of power needed to maintain a level of tint. The power stored in the first power storage device 406a may subsequently be used when one or more smart glass units of the smart glass units 408 are to perform tint switching. In some aspects, the first controller 404a may prevent power from communicating from the power communication line 405a to the first power storage device 406a (and/or the second power storage device 406b) when the power storage devices 406a and 406b are fully charged and may instead redirect power to the second controller 404b for power allocation by the second controller 404b to one or more other smart glass units (not shown) that are the same as or similar to the smart glass units 408.

As another example, the first controller 404a may determine that the level of charge of the first power storage device 406a (and/or the second power storage device 406b) is not without charged (e.g., partially charged, fully charged). The first controller 404a may also determine a current tinting level of the first smart glass unit 408a and receive a directed tinting level for the first smart glass unit 408a. The first controller 404a may determine that the directed tinting level for the first smart glass unit 408a is a greater (e.g. darker) tinting level compared to the current tint level of the first smart glass unit 408a. Based on determining the first power storage device 406a (and/or the second power storage device 406b) is not without charge and determining that the directed tinting level for the first smart glass unit 408a is a greater (e.g., darker) tinting level than the current tint level of the first smart glass unit 408a, the first controller 404a may allocate power from the power communication line 405a of the data communication cable 405 to the first smart glass unit 408a and at least some power from the first power storage device 406a to increase the level of tint of the first smart glass unit 408a to the directed tinting level. The first controller 404a may determine to allocate power from the power communication line 405a and the first power storage device 406a due to the greater amount of power needed to increase a level of tint. In some aspects, the power stored in the first power storage device 406a and/or the power communication line 405a may subsequently be used when one or more smart glass units of the smart glass units 408 are to maintain a tint.

As another example, the first controller 404a may determine that the level of charge of the first power storage device 406a (and/or the second power storage device 406b) is fully charged. The first controller 404a may also determine a current tinting level of the first smart glass unit 408a and receive a directed tinting level for the first smart glass unit 408a. The first controller 404a may determine that the directed tinting level for the first smart glass unit 408a is the lesser tinting level (e.g., so that the smart glass is not as tinted) as the current tint level of the first smart glass unit 408a. Based on determining the first power storage device 406a (and/or the second power storage device 406b) is fully charged and determining that the directed tinting level for the first smart glass unit 408a is a lesser than the current tint level of the first smart glass unit 408a, the first controller 404a may allocate power from the power storage device 406a to the first smart glass unit 408a to decrease the current level of tint of the first smart glass unit 408a to the directed level of tint. The first controller 404a may determine to allocate power from the first power storage device 406a instead of from the power communication line 405a due to the greater amount of power needed to perform tint switching.

As yet another example, the first controller 404a may determine that the level of charge of the first power storage device 406a (and/or the second power storage device 406b) is not fully charged. The first controller 404a may also determine a current tinting level of the first smart glass unit 408a and receive a directed tinting level for the first smart glass unit 408a. The first controller 404a may determine that the directed tinting level for the first smart glass unit 408a is the same tinting level as the current tint level of the first smart glass unit 408a. Based on determining the first power storage device 406a (and/or the second power storage device 406b) is not fully charged and determining that the directed tinting level for the first smart glass unit 408a is the same as the current tint level of the first smart glass unit 408a, the first controller 404a may determine an amount of power available through the power communication line 405a. When the first controller 404a determines that the power communication line 405a provides enough power to maintain the current level of tint for the first smart glass unit 408a, the first controller 404a may allocate power from the power communication line 405a to the first smart glass unit 408a to maintain the level of tint of the first smart glass unit 408a at the current tinting level. Alternatively, when the first controller 404a determines that the power communication line 405a provides more than enough power to maintain the current level of tint for the first smart glass unit 408a, the first controller 404a may allocate power from the power communication line 405a to the first smart glass unit 408a to maintain the level of tint of the first smart glass unit 408a at the current tinting level and a remaining amount of power from the power communication line 405a to the first power storage device 406a (and/or the second power storage device 406b) for power storage. The first controller 404a may allocate the remaining amount of power from the power communication line 405a to the first power storage device 406a until the first controller 404a determines that the first power storage device 406a (and/or the second power storage device 406b) is fully charged.

As yet another example, the first controller 404a may determine that the level of charge of the first power storage device 406a (and/or the second power storage device 406b) is not fully charged. The first controller 404a may also determine a current tinting level of the first smart glass unit 408a and receive a directed tinting level for the first smart glass unit 408a. The first controller 404a may determine that the directed tinting level for the first smart glass unit 408a is above a current tint level of the first smart glass unit 408a. Based on determining the first power storage device 406a (and/or the second power storage device 406b) is not fully charged and determining that the directed tinting level for the first smart glass unit 408a is above a current tint level of the first smart glass unit 408a, the first controller 404a may determine an amount of power available in the first power storage device 406a. When the first controller 404a determines that the first power storage device 406a contains enough power to transition the first smart glass unit 408a from the current level of tint to the directed level of tint, the first controller 404a may allocate power from the first power storage device 406a (and/or the second power storage device 406b) to the first smart glass unit 408a to increase the level of tint of the first smart glass unit 408a from the current tinting level to the directed tinting level. The first controller 404a may determine to allocate power from the first power storage device 406a instead of from the power communication line 405a due to the greater amount of power needed to perform tint switching. Alternatively, when the first controller 404a determines that the first power storage device 406a does not contain enough power to transition the first smart glass unit 408a from the current level of tint to the directed level of tint, the first controller 404a may allocate power from the power communication line 405a to the first power storage device 406a (and/or the second power storage device 406b) until the first power storage device 406a has enough power to transition the first smart glass unit 408a from the current level of tint to the directed level of tint. Subsequently, when the first controller 404a determines that the first power storage device 406a contains enough power to transition the first smart glass unit 408a from the current level of tint to the directed level of tint, the first controller 404a may allocate power from the first power storage device 406a (and/or the second power storage device 406b) to the first smart glass unit 408a to increase the level of tint of the first smart glass unit 408a from the current tinting level to the directed tinting level.

As yet another example, the first controller 404a may determine that the level of charge of the first power storage device 406a (and/or the second power storage device 406b) is not fully charged. The first controller 404a may also determine a current tinting level of the first smart glass unit 408a and receive a directed tinting level for the first smart glass unit 408a. The first controller 404a may determine that the directed tinting level for the first smart glass unit 408a and the current tint level of the first smart glass unit 408a is no tint. Based on determining the first power storage device 406a (and/or the second power storage device 406b) is not fully charged and determining that the directed tinting level for the first smart glass unit 408a and the current tint level of the first smart glass unit 408a is no tint, the first controller 404a may allocate power from the power communication line 405a to the first power storage device 406a (and/or the second power storage device 406b) to charge the first power storage device 406a (and/or the second power storage device 406b). The first controller 404a may determine to allocate power from the power communication line 405a to the first power storage device 406a (and/or the second power storage device 406b) for charging so that the first power storage device 406a (and/or the second power storage device 406b) may be subsequently used to perform tint switching for one or more smart glass units of the smart glass units 408.

As yet another example, the first controller 404a may determine that the level of charge of the first power storage device 406a (and/or the second power storage device 406b) is not without charge. The first controller 404a may also determine that a current tinting level of the first smart glass unit 408a is to be maintained or changed based on determining the current tinting level and receiving a directed tinting level for the first smart glass unit 408a. Based on determining the first power storage device 406a (and/or the second power storage device 406b) is not without charge and determining that that a current tinting level of the first smart glass unit 408a is to be maintained or changed, the first controller 404a may determine an amount of power available from the power communication line 405a. When the first controller 404a determines that the amount of power available from the power communication line 405a is no power, the first controller 404a may allocate power from the first power storage device 406a (and/or the second power storage device 406b) to the first smart glass unit 408a to maintain or change a level of tint of the first smart glass unit 408a.

As yet another example, the first controller 404a may determine that the level of charge of the first power storage device 406a (and/or the second power storage device 406b) is not without charge. The first controller 404a may also determine that a current tinting level of the first smart glass unit 408a is to be maintained based on determining the current tinting level and receiving a directed tinting level for the first smart glass unit 408a. The first controller 404a may also determine that a current tinting level of the second smart glass unit 408b is to be changed based on determining the current tinting level of the second smart glass unit 408b and receiving a directed tinting level for the second smart glass unit 408b. Based on determining the first power storage device 406a (and/or the second power storage device 406b) is not without charge, determining that the current tinting level of the first smart glass unit 408a is to be maintained, and determining that the current tinting level of the second smart glass unit 408b is to be changed, the first controller 404a may determine whether power is available from the power communication line 405a. When the first controller 404a determines that power is available from the power communication line 405a, the first controller 404a may allocate power from the power communication line 405a to the first smart glass unit 408a to maintain a level of tint for the first smart glass unit 408a and the first controller 404a may allocate power from the first power storage device 406a (and/or the second power storage device 406b) to the second smart glass unit 408b to change a level of tint of the second smart glass unit 408b.

As yet another example, the first controller 404a may determine that the level of charge of the first power storage device 406a (and/or the second power storage device 406b) is not without charge. The first controller 404a may also determine that a current tinting level of the first smart glass unit 408a is to be maintained based on determining the current tinting level and receiving a directed tinting level for the first smart glass unit 408a. Based on determining the first power storage device 406a (and/or the second power storage device 406b) is not without charge and determining that that a current tinting level of the first smart glass unit 408a is to be maintained, the first controller 404a may determine an amount of power available from the power communication line 405a. When the first controller 404a determines that the amount of power available from the power communication line 405a is no power, the first controller 404a may allocate some power from the first power storage device 406a (and/or the second power storage device 406b) to the first smart glass unit 408a to maintain a level of tint of the first smart glass unit 408a. In addition, the first controller 404a may allocate another portion of power from the first power storage device 406a (and/or the second power storage device 406b) to the second controller 404b so that the second controller 404b may allocate power to one or more smart glass units (not shown) associated with the second controller 404b.

FIG. 5 illustrates a block diagram of an example method 500 according to some aspects of this disclosure. In some aspects, the method 500 may be implemented using the system 100 illustrated in FIG. 1, the system 200 illustrated in FIG. 2, the system 300 illustrated in FIG. 3, the system 400 illustrated in FIG. 4, and/or the computer system 1800 illustrated in FIG. 18. One or more steps or one or more aspects of the method 500 may be included with and/or include one or more steps or one or more aspects of the method 600 illustrated in FIG. 6, the method 700 illustrated in FIG. 7, the method 800 illustrated in FIG. 8, the method 900 illustrated in FIG. 9, the method 1000 illustrated in FIG. 10, the method 1100 illustrated in FIG. 11, the method 1200 illustrated in FIG. 12, the method 1300 illustrated in FIG. 13, the method 1400 illustrated in FIG. 14, the method 1500 illustrated in FIG. 15, the method 1600 illustrated in FIG. 16, and/or the method 1700 illustrated in FIG. 17. FIG. 5, as with the other included figures, is shown for illustrative purposes and does not limit either the possible embodiments of the present invention or the claims.

In some aspects, the method 500 may be implemented using the system 400 illustrated in FIG. 4. For instance, at step 501, the controller 404a may determine that one or more smart glass units 408 are to change a level of tinting from a current level of tinting to a new level of tinting. For example, the controller 404a may receive an indication from one or more of the sensors 414 (e.g., positioned on and/or near one or more of the smart glass units 408) that the amount of sun light reaching the smart glass units 408 has increased, decreased, or remained the same. In response, the controller 404a may determine that one or more of the smart glass units 408 are to transition or change from a current level of tinting to a new level of tinting. For instance, when the controller 404a receives an indication from one or more of the sensors 414 that the amount of sun light reaching one or more of the smart glass units 408 has increased from a previous time, the controller 404a may determine that the one or more smart glass units 408 are to change a level of tinting from the current level of tinting to a new level of tinting that is a greater than (e.g., a darker) the current level of tinting to maintain a same amount of sun light penetrating through the smart glass units 408. Additionally, or alternatively, when the controller 404a receives an indication from one or more of the sensors 414 that the amount of sun light reaching one or more of the smart glass units 408 has decreased from a previous time, the controller 404a may determine that the one or more smart glass units 408 are to change a level of tinting from the current level of tinting to a new level of tinting that is a less than (e.g., lighter) the current level of tinting to maintain a same amount of sun light penetrating through the smart glass units 408. Additionally, or alternatively, when the controller 404a receives an indication from one or more of the sensors 414 that the amount of sun light reaching one or more of the smart glass units 408 remains the same as a previous time, the controller 404a may determine that the one or more smart glass units 408 are to maintain the current level of tinting such that the new level of tinting is the same as the current level of tinting to maintain a same amount of sun light penetrating through the smart glass units 408. Additionally, or alternatively, the controller 404a may determine that one or more of the smart glass units 408 are to transition or change from a current level of tinting to a new level of tinting an indication based on one or more inputs received from the user interface 407. For example, the controller 404a may determine that one or more of the smart glass units 408 are to transition or change from a current level of tinting to a new level of tinting an indication based on one or more inputs received from the user interface 407 indicating that the smart glass is to increase a level of tinting (e.g., become darker), decrease a level of tinting (e.g., become lighter), or maintain a level of tinting (e.g., maintain a same level of tinting.)

At step 503, the controller 404a may determine an amount of power needed to change a level of tinting of the one or more smart glass unit 408 from the current level of tinting to the new level of tinting. For example, the controller 404a may determine an amount of power need to increase the level of tinting from the current level of tinting to the new level of tinting, decrease the level of tinting from the current level of tinting to the new level of tinting, or an amount of power need to maintain a same level of tinting from the current level of tinting to the new level of tinting. At step 505, the controller 404a may determine whether a power storage device (e.g., the first power storage device 406a and/or the second power storage device 406b), a data communication cable (e.g., the data communication cable 405), or a combination of the power storage device and the data communication cable have enough power to change the level of tinting from the current level of tinting to the new level of tinting. For example, the controller 404a may determine that none of the power storage device, the data communication cable, or a combination of the power storage device and the data communication cable have enough power to change the level of tinting from the current level of tinting to the new level of tinting. Then, at step 507, the controller 404a may slow or prevent the one or more smart glass units 408 from changing a level of tinting from the current level of tinting to the new level of tinting. As another example, the controller 404a may determine that enough power is available from the power storage device, the data communication cable, or a combination of the power storage device and the data communication cable to change the level of tinting from the current level of tinting to the new level of tinting. Then, at step 509, the controller 404a may use or utilize the power available from the power storage device, the data communication cable, or a combination of the power storage device and the data communication cable to change the level of tinting from the current level of tinting to the new level of tinting.

FIG. 6 illustrates a block diagram of an example method 600 according to some aspects of this disclosure. In some aspects, the method 600 may be implemented using the system 100 illustrated in FIG. 1, the system 200 illustrated in FIG. 2, the system 300 illustrated in FIG. 3, the system 400 illustrated in FIG. 4, and/or the computer system 1800 illustrated in FIG. 18. One or more steps or one or more aspects of the method 600 may be included with and/or include one or more steps or one or more aspects of the method 500 illustrated in FIG. 5, the method 700 illustrated in FIG. 7, the method 800 illustrated in FIG. 8, the method 900 illustrated in FIG. 9, the method 1000 illustrated in FIG. 10, the method 1100 illustrated in FIG. 11, the method 1200 illustrated in FIG. 12, the method 1300 illustrated in FIG. 13, the method 1400 illustrated in FIG. 14, the method 1500 illustrated in FIG. 15, the method 1600 illustrated in FIG. 16, and/or the method 1700 illustrated in FIG. 17. FIG. 6, as with the other included figures, is shown for illustrative purposes and does not limit either the possible embodiments of the present invention or the claims.

In some aspects, the method 600 may be implemented using the system 400 illustrated in FIG. 4. For instance, at step 601, the controller 404a may determine an amount of power needed for a directed level of tinting for at least one smart glass unit of the one or more smart glass units 408. For example, the controller 404a may receive an indication (e.g., from one or more of the sensors 414 and/or from a user interface 407) that one or more of the smart glass units 408 are to transition or change from a current level of tinting to a new (or directed) level of tinting. For instance, the controller 404a may receive an indication that the one or more smart glass units 408 are to change a level of tinting from the current level of tinting to a new level of tinting that is a greater than (e.g., a darker) the current level of tinting, to a new level of tinting that is a less than (e.g., lighter) the current level of tinting, and/or to maintain the current level of tinting such that the new level of tinting is the same as the current level of tinting.

At step 601, the controller 404a may determine an amount of power available through a data communication cable (e.g., the data communication cable 405) for changing a level of tinting of the one or more smart glass unit 408 from the current level of tinting to the new or directed level of tinting. At step 605, the controller 404a may determine whether an amount of power needed for the new or directed level of tinting is greater than the amount of power available through the data communication cable. For example, when the controller 404a determines that the amount of power needed for the new or directed level of tinting is not greater than the amount of power available through the data communication cable, then, at step 607, the controller 404a may determine whether power storage device(s) (e.g., the first power storage device 406a and/or the second power storage device 406b) is fully charged. When the controller 404a determines that the power storage device(s) are fully charged, then, at step 609, the controller 404a may use or utilize the power available through the data communication cable to change a level of tinting of the one or more smart glass units 408 from the current level of tinting to the new or directed level of tinting. When the controller 404a determines that the power storage device(s) are not fully charged, then, at step 611, the controller 404a may use or utilize the power available through the data communication cable to change a level of tinting of the one or more smart glass units 408 from the current level of tinting to the new or directed level of tinting and use of utilize the power available through the data communication cable to charge the power storage device(s).

Returning back to step 605, as another example, when the controller 404a determines that the amount of power needed for the new or directed level of tinting is greater than the amount of power available through the data communication cable, then, at step 613, the controller 404a may determine whether power storage device(s) (e.g., the first power storage device 406a and/or the second power storage device 406b) have no charge. When the controller 404a determines that the power storage device(s) have no charge, then, at step 615, the controller 404a may slow or prevent the one or more smart glass units 408 from changing a level of tinting from the current level of tinting to the new or directed level of tinting. When the controller 404a determines that the power storage device(s) are not without charge, then, at step 617, the controller 404a may use or utilize the power available from the power storage device(s) (e.g., in combination with power from the data communication cable or without power from the data communication cable) to change a level of tinting of the one or more smart glass units 408 from the current level of tinting to the new or directed level of tinting.

FIG. 7 illustrates a block diagram of an example method 700 according to some aspects of this disclosure. In some aspects, the method 700 may be implemented using the system 100 illustrated in FIG. 1, the system 200 illustrated in FIG. 2, the system 300 illustrated in FIG. 3, the system 400 illustrated in FIG. 4, and/or the computer system 1800 illustrated in FIG. 18. One or more steps or one or more aspects of the method 700 may be included with and/or include one or more steps or one or more aspects of the method 500 illustrated in FIG. 5, the method 600 illustrated in FIG. 6, the method 800 illustrated in FIG. 8, the method 900 illustrated in FIG. 9, the method 1000 illustrated in FIG. 10, the method 1100 illustrated in FIG. 11, the method 1200 illustrated in FIG. 12, the method 1300 illustrated in FIG. 13, the method 1400 illustrated in FIG. 14, the method 1500 illustrated in FIG. 15, the method 1600 illustrated in FIG. 16, and/or the method 1700 illustrated in FIG. 17. FIG. 7, as with the other included figures, is shown for illustrative purposes and does not limit either the possible embodiments of the present invention or the claims.

In some aspects, the method 700 may be implemented using the system 400 illustrated in FIG. 4. For instance, at step 701, a controller may determine a level of charge of charge of a power storage device. For example, the first controller 404a may send a signal to the first power storage device 406a and/or the second power storage device 406b for determining an amount of power currently stored within the first power storage device 406a and/or the second power storage device 406b. As another example, the first controller 404a may determine an amount of power currently stored within the first power storage device 406a and/or the second power storage device 406b. Step 701 may be the same as or at least similar to step 801 of FIG. 8, step 901 of FIG. 9, step 1001 of FIG. 10, step 1101 of FIG. 11, step 1201 of FIG. 12, step 1301 of FIG. 13, step 1401 of FIG. 14, step 1501 of FIG. 15, step 1601 of FIG. 16, and/or step 1701 of FIG. 17 and may include one or more same or similar features described at least with respect to step 801 of FIG. 8, step 901 of FIG. 9, step 1001 of FIG. 10, step 1101 of FIG. 11, step 1201 of FIG. 12, step 1301 of FIG. 13, step 1401 of FIG. 14, step 1501 of FIG. 15, step 1601 of FIG. 16, and/or step 1701 of FIG. 17.

At step 703, the controller may identify a current tinting level of at least one smart glass unit of one or more smart glass units. For example, the first controller 404a may determine or identify a current tinting level of the first smart glass unit 408a from one or more data sources (e.g., a network system, central controller, building automation system, personal computer, handheld electronic device, or the like). Step 703 may be the same as or at least similar to step 803 of FIG. 8, step 903 of FIG. 9, step 1003 of FIG. 10, step 1103 of FIG. 11, step 1203 of FIG. 12, step 1303 of FIG. 13, step 1403 of FIG. 14, step 1501 of FIG. 15, step 1603 of FIG. 16, and/or step 1703 of FIG. 17 and may include one or more same or similar features described at least with respect to step 803 of FIG. 8, step 903 of FIG. 9, step 1003 of FIG. 10, step 1103 of FIG. 11, step 1203 of FIG. 12, step 1303 of FIG. 13, step 1403 of FIG. 14, step 1503 of FIG. 15, step 1603 of FIG. 16, and/or step 1703 of FIG. 17.

At step 705, the controller may identify a directed tinting level for the at least one smart glass unit of the one or more smart glass units. For example, the first controller 404a may determine a directed tinting level of the first smart glass unit 408a using one or more sensors (e.g., light sensors mounted on or near the first smart glass unit 408a) and/or from one or more data sources (e.g., a network system, central controller, building automation system, personal computer, handheld electronic device, or the like) indicating a received directed input or a tinting schedule for the first smart glass unit 408a. Step 705 may be the same as or at least similar to step 805 of FIG. 8, step 905 of FIG. 9, step 1005 of FIG. 10, step 1105 of FIG. 11, step 1205 of FIG. 12, step 1305 of FIG. 13, step 1405 of FIG. 14, and/or step 1505 of FIG. 15 and may include one or more same or similar features described at least with respect to step 601 of FIG. 6, step 705 of FIG. 7, step 805 of FIG. 8, step 905 of FIG. 9, step 1005 of FIG. 10, step 1105 of FIG. 11, step 1205 of FIG. 12, step 1305 of FIG. 13, step 1405 of FIG. 14, step 1505 of FIG. 15, step 1605 of FIG. 16, and/or step 1705 of FIG. 17.

At step 707, the controller may allocate (e.g., direct, control) power from at least one of a power communication line of a data communication cable or the power storage device and to the at least one smart glass unit of the one or more smart glass units to control a level of tint of the at least one smart glass unit. In some aspects, the controller may allocate (e.g., direct, control) power from at least one of a power communication line of a data communication cable or the power storage device and to the at least one smart glass unit of the one or more smart glass units to control a level of tint of the at least one smart glass unit based on the level of charge of the power storage device, the current tinting level of the least one smart glass unit, and the directed tinting level for the at least one smart glass unit. For example, the first controller 404a may determine (e.g., receive an indication of) a level of charge of the first power storage device 406a (and/or the second power storage device 406b), identify (e.g., a receive an indication of) a current tinting level of first smart glass unit 408a of the smart glass units 408, and identify (e.g., a receive an indication of) a directed tinting level for the first smart glass unit 408a. Based on the level of charge of the first power storage device 406a (and/or the second power storage device 406b), the current tinting level of the first smart glass unit 408a, and the directed tinting level for the first smart glass unit 408, the first controller 404a may allocate power from at least one of the power communication line 405a or the first power storage device 406a (and/or the second power storage device 406b) and to the first smart glass unit 408a to control a level of tint of the first smart glass unit 408a.

Please note that the functional block(s) described herein are illustrated in FIG. 7 in merely one example arrangement. In other embodiments, the techniques and functionality described above may be performed using different steps in different orders or may be grouped into a different number of steps or may be performed as a single method without distinct steps.

FIG. 8 illustrates a block diagram of an example method 800 according to some aspects of this disclosure. In some aspects, the method 800 may be implemented using the system 100 illustrated in FIG. 1, the system 200 illustrated in FIG. 2, the system 300 illustrated in FIG. 3, the system 400 illustrated in FIG. 4, and/or the computer system 1800 illustrated in FIG. 18. One or more steps or one or more aspects of the method 800 may be included with and/or include one or more steps or one or more aspects of the method 500 illustrated in FIG. 5, the method 600 illustrated in FIG. 6, the method 700 illustrated in FIG. 7, the method 700 illustrated in FIG. 7, the method 900 illustrated in FIG. 9, the method 1000 illustrated in FIG. 10, the method 1100 illustrated in FIG. 11, the method 1200 illustrated in FIG. 12, the method 1300 illustrated in FIG. 13, the method 1400 illustrated in FIG. 14, and/or the method 1500 illustrated in FIG. 15. FIG. 8, as with the other included figures, is shown for illustrative purposes and does not limit either the possible embodiments of the present invention or the claims.

In some aspects, the method 800 may be implemented using the system 400 illustrated in FIG. 4. At step 801, a controller may determine a level of charge of charge of a power storage device. Step 801 may be the same as or at least similar to step 701 of FIG. 7, step 801 of FIG. 8, step 901 of FIG. 9, step 1001 of FIG. 10, step 1101 of FIG. 11, step 1201 of FIG. 12, step 1301 of FIG. 13, step 1401 of FIG. 14, step 1501 of FIG. 15, step 1601 of FIG. 16, and/or step 1701 of FIG. 17 and may include one or more same or similar features described at least with respect to step 701 of FIG. 7, step 901 of FIG. 9, step 1001 of FIG. 10, step 1101 of FIG. 11, step 1201 of FIG. 12, step 1301 of FIG. 13, step 1401 of FIG. 14, step 1501 of FIG. 15, step 1601 of FIG. 16, and/or step 1701 of FIG. 17.

At step 803, the controller may identify a current tinting level of at least one smart glass unit of one or more smart glass units. Step 803 may be the same as or at least similar to step 703 of FIG. 7, step 903 of FIG. 9, step 1003 of FIG. 10, step 1103 of FIG. 11, step 1203 of FIG. 12, step 1303 of FIG. 13, step 1403 of FIG. 14, step 1503 of FIG. 15, step 1603 of FIG. 16, and/or step 1703 of FIG. 17 and may include one or more same or similar features described at least with respect to step 703 of FIG. 7, step 903 of FIG. 9, step 1003 of FIG. 10, step 1103 of FIG. 11, step 1203 of FIG. 12, step 1303 of FIG. 13, step 1403 of FIG. 14, step 1503 of FIG. 15, step 1603 of FIG. 16, and/or step 1703 of FIG. 17.

At step 805, the controller may identify a directed tinting level for the at least one smart glass unit of the one or more smart glass units. Step 805 may be the same as or at least similar to step 705 of FIG. 7, step 905 of FIG. 9, step 1005 of FIG. 10, step 1105 of FIG. 11, step 1205 of FIG. 12, step 1305 of FIG. 13, step 1405 of FIG. 14, step 1505 of FIG. 15, step 1605 of FIG. 16, and/or step 1705 of FIG. 17 and may include one or more same or similar features described at least with respect to step 705 of FIG. 7, step 905 of FIG. 9, step 1005 of FIG. 10, step 1105 of FIG. 11, step 1205 of FIG. 12, step 1305 of FIG. 13, step 1405 of FIG. 14, step 1505 of FIG. 15, step 1606 of FIG. 16, and/or step 1705 of FIG. 17.

At step 807, the controller may allocate (e.g., direct, control) power from at least one of a power communication line of a data communication cable or the power storage device and to the at least one smart glass unit of the one or more smart glass units to control a level of tint of the at least one smart glass unit. In some aspects, the controller may allocate (e.g., direct, control) power from at least one of a power communication line of a data communication cable or the power storage device and to the at least one smart glass unit of the one or more smart glass units to control a level of tint of the at least one smart glass unit based on the level of charge of the power storage device, the current tinting level of the least one smart glass unit, and the directed tinting level for the at least one smart glass unit. For example, the first controller 404a may determine that the level of charge of the first power storage device 406a (and/or the second power storage device 406b) is fully charged. The first controller 404a may also determine a current tinting level of the first smart glass unit 408a and receive a directed tinting level for the first smart glass unit 408a. The first controller 404a may determine that the directed tinting level for the first smart glass unit 408a is above a current tint level of the first smart glass unit 408a. Based on determining the first power storage device 406a (and/or the second power storage device 406b) is fully charged and determining that the directed tinting level for the first smart glass unit 408a is above a current tint level of the first smart glass unit 408a, the first controller 404a may allocate power from the first power storage device 406a (and/or the second power storage device 406b) to the first smart glass unit 408a to increase the level of tint of the first smart glass unit 408a from the current tinting level to the directed tinting level. The first controller 404a may determine to allocate power from the first power storage device 406a instead of from the power communication line 405a due to the greater amount of power needed to perform tint switching.

Please note that the functional block(s) described herein are illustrated in FIG. 8 in merely one example arrangement. In other embodiments, the techniques and functionality described above may be performed using different steps in different orders or may be grouped into a different number of steps or may be performed as a single method without distinct steps.

FIG. 9 illustrates a block diagram of an example method 900 according to some aspects of this disclosure. In some aspects, the method 900 may be implemented using the system 100 illustrated in FIG. 1, the system 200 illustrated in FIG. 2, the system 300 illustrated in FIG. 3, the system 400 illustrated in FIG. 4, and/or the computer system 1800 illustrated in FIG. 18. One or more steps or one or more aspects of the method 900 may be included with and/or include one or more steps or one or more aspects of the method 500 illustrated in FIG. 5, the method 600 illustrated in FIG. 6, the method 700 illustrated in FIG. 7, the method 800 illustrated in FIG. 8, the method 1000 illustrated in FIG. 10, the method 1100 illustrated in FIG. 11, the method 1200 illustrated in FIG. 12, the method 1300 illustrated in FIG. 13, the method 1400 illustrated in FIG. 14, the method 1500 illustrated in FIG. 15, the method 1600 illustrated in FIG. 16, and/or the method 1700 illustrated in FIG. 17. FIG. 9, as with the other included figures, is shown for illustrative purposes and does not limit either the possible embodiments of the present invention or the claims.

In some aspects, the method 900 may be implemented using the system 400 illustrated in FIG. 4. At step 901, a controller may determine a level of charge of charge of a power storage device. Step 901 may be the same as or at least similar to step 701 of FIG. 7, step 801 of FIG. 8, step 901 of FIG. 9, step 1001 of FIG. 10, step 1101 of FIG. 11, step 1201 of FIG. 12, step 1301 of FIG. 13, step 1401 of FIG. 14, step 1501 of FIG. 15, step 1601 of FIG. 16, and/or step 1701 of FIG. 17 and may include one or more same or similar features described at least with respect to step 701 of FIG. 7, step 801 of FIG. 8, step 901 of FIG. 9, step 1001 of FIG. 10, step 1101 of FIG. 11, step 1201 of FIG. 12, step 1301 of FIG. 13, step 1401 of FIG. 14, step 1501 of FIG. 15, step 1601 of FIG. 16, and/or step 1701 of FIG. 17.

At step 903, the controller may identify a current tinting level of at least one smart glass unit of one or more smart glass units. Step 903 may be the same as or at least similar to step 703 of FIG. 7, step 803 of FIG. 8, step 1003 of FIG. 10, step 1103 of FIG. 11, step 1203 of FIG. 12, step 1303 of FIG. 13, step 1403 of FIG. 14, step 1503 of FIG. 15, step 1603 of FIG. 16, and/or step 1703 of FIG. 17 and may include one or more same or similar features described at least with respect to step step 703 of FIG. 7, step 803 of FIG. 8, step 1003 of FIG. 10, step 1103 of FIG. 11, step 1203 of FIG. 12, step 1303 of FIG. 13, step 1403 of FIG. 14, step 1503 of FIG. 15, step 1603 of FIG. 16, and/or step 1703 of FIG. 17.

At step 905, the controller may identify a directed tinting level for the at least one smart glass unit of the one or more smart glass units. Step 905 may be the same as or at least similar to step 705 of FIG. 7, step 805 of FIG. 8, step 1005 of FIG. 10, step 1105 of FIG. 11, step 1205 of FIG. 12, step 1305 of FIG. 13, step 1405 of FIG. 14, step 1505 of FIG. 15, step 1605 of FIG. 16, and/or step 1705 of FIG. 17 and may include one or more same or similar features described at least with respect to step 705 of FIG. 7, step 805 of FIG. 8, step 1005 of FIG. 10, step 1105 of FIG. 11, step 1205 of FIG. 12, step 1305 of FIG. 13, step 1405 of FIG. 14, step 1505 of FIG. 15, step 1605 of FIG. 16, and/or step 1705 of FIG. 17.

At step 907, the controller may allocate (e.g., direct, control) power from the power storage device to the at least one smart glass unit to increase the level of tint of the at least one smart glass unit from the current tinting level to the directed tinting level. In some aspects, the controller may allocate (e.g., direct, control) power from the power storage device to the at least one smart glass unit to increase the level of tint of the at least one smart glass unit from the current tinting level to the directed tinting level when the level of charge of the power storage device is fully charged and the directed tinting level for the at least one smart glass unit is above the current tinting level of the at least one smart glass unit. For example, the first controller 404a may determine that the level of charge of the first power storage device 406a (and/or the second power storage device 406b) is fully charged. The first controller 404a may also determine a current tinting level of the first smart glass unit 408a and receive a directed tinting level for the first smart glass unit 408a. The first controller 404a may determine that the directed tinting level for the first smart glass unit 408a is above a current tint level of the first smart glass unit 408a. Based on determining the first power storage device 406a (and/or the second power storage device 406b) is fully charged and determining that the directed tinting level for the first smart glass unit 408a is above a current tint level of the first smart glass unit 408a, the first controller 404a may allocate power from the first power storage device 406a (and/or the second power storage device 406b) to the first smart glass unit 408a to increase the level of tint of the first smart glass unit 408a from the current tinting level to the directed tinting level. The first controller 404a may determine to allocate power from the first power storage device 406a instead of from the power communication line 405a due to the greater amount of power needed to perform tint switching. At step 709, the controller 404a may allocate power from the power communication line to at least one of the power storage device or the at least one smart glass unit of the one or more smart glass units.

Please note that the functional block(s) described herein are illustrated in FIG. 9 in merely one example arrangement. In other embodiments, the techniques and functionality described above may be performed using different steps in different orders or may be grouped into a different number of steps or may be performed as a single method without distinct steps.

FIG. 10 illustrates a block diagram of an example method 1000 according to some aspects of this disclosure. In some aspects, the method 1000 may be implemented using the system 100 illustrated in FIG. 1, the system 200 illustrated in FIG. 2, the system 300 illustrated in FIG. 3, the system 400 illustrated in FIG. 4, and/or the computer system 1800 illustrated in FIG. 18. One or more steps or one or more aspects of the method 1000 may be included with and/or include one or more steps or one or more aspects of the method 500 illustrated in FIG. 5, the method 600 illustrated in FIG. 6, the method 700 illustrated in FIG. 7, the method 800 illustrated in FIG. 8, the method 900 illustrated in FIG. 9, the method 1100 illustrated in FIG. 11, the method 1200 illustrated in FIG. 12, the method 1300 illustrated in FIG. 13, the method 1400 illustrated in FIG. 14, the method 1500 illustrated in FIG. 15, the method 1600 illustrated in FIG. 16, and/or the method 1700 illustrated in FIG. 17. FIG. 10, as with the other included figures, is shown for illustrative purposes and does not limit either the possible embodiments of the present invention or the claims.

In some aspects, the method 1000 may be implemented using the system 400 illustrated in FIG. 4. At step 1001, a controller may determine a level of charge of charge of a power storage device. Step 1001 may be the same as or at least similar to step 701 of FIG. 7, step 801 of FIG. 8, step 901 of FIG. 9, step 1101 of FIG. 11, step 1201 of FIG. 12, step 1301 of FIG. 13, step 1401 of FIG. 14, step 1501 of FIG. 15, step 1601 of FIG. 16, and/or step 1701 of FIG. 17 and may include one or more same or similar features described at least with respect to step 701 of FIG. 7, step 801 of FIG. 8, step 901 of FIG. 9, step 1001 of FIG. 10, step 1101 of FIG. 11, step 1201 of FIG. 12, step 1301 of FIG. 13, step 1401 of FIG. 14, step 1501 of FIG. 15, step 1601 of FIG. 16, and/or step 1701 of FIG. 17.

At step 1003, the controller may identify a current tinting level of at least one smart glass unit of one or more smart glass units. Step 1003 may be the same as or at least similar to step 703 of FIG. 7, step 803 of FIG. 8, step 903 of FIG. 9, step 1103 of FIG. 11, step 1203 of FIG. 12, step 1303 of FIG. 13, step 1403 of FIG. 14, step 1503 of FIG. 15, step 1603 of FIG. 16, and/or step 1703 of FIG. 17 and may include one or more same or similar features described at least with respect to step 703 of FIG. 7, step 803 of FIG. 8, step 903 of FIG. 9, step 1103 of FIG. 11, step 1203 of FIG. 12, step 1303 of FIG. 13, step 1403 of FIG. 14, step 1503 of FIG. 15, step 1603 of FIG. 16, and/or step 1703 of FIG. 17.

At step 1005, the controller may identify a directed tinting level for the at least one smart glass unit of the one or more smart glass units. Step 1005 may be the same as or at least similar to step 705 of FIG. 7, step 805 of FIG. 8, step 905 of FIG. 9, step 1105 of FIG. 11, step 1205 of FIG. 12, step 1305 of FIG. 13, step 1405 of FIG. 14, step 1505 of FIG. 15, step 1605 of FIG. 16, and/or step 1705 of FIG. 17 and may include one or more same or similar features described at least with respect to step 705 of FIG. 7, step 805 of FIG. 8, step 905 of FIG. 9, step 1105 of FIG. 11, step 1205 of FIG. 12, step 1305 of FIG. 13, step 1405 of FIG. 14, step 1505 of FIG. 15, step 1605 of FIG. 16, and/or step 1705 of FIG. 17.

At step 1007, the controller may allocate (e.g., direct, control) power from the power communication line to the at least one smart glass unit to maintain the current tinting level of the at least one smart glass unit. For example, the first controller 404a may determine that the level of charge of the first power storage device 406a (and/or the second power storage device 406b) is fully charged. The first controller 404a may also determine a current tinting level of the first smart glass unit 408a and receive a directed tinting level for the first smart glass unit 408a. The first controller 404a may determine that the directed tinting level for the first smart glass unit 408a is the same tinting level as the current tint level of the first smart glass unit 408a. Based on determining the first power storage device 406a (and/or the second power storage device 406b) is fully charged and determining that the directed tinting level for the first smart glass unit 408a is the same as the current tint level of the first smart glass unit 408a, the first controller 404a may allocate power from the power communication line 405a of the data communication cable 405 to the first smart glass unit 408a to maintain the current level of tint of the first smart glass unit 408a. The first controller 404a may determine to allocate power from the power communication line 405a instead of the first power storage device 406a due to the lesser amount of power needed to maintain a level of tint. The power stored in the first power storage device 406a may subsequently be used when one or more smart glass units of the smart glass units 408 are to perform tint switching. In some aspects, the first controller 404a may prevent power from communicating from the power communication line 405a to the first power storage device 406a (and/or the second power storage device 406b) when the power storage devices 406a and 406b are fully charged and may instead redirect power to the second controller 404b for power allocation by the second controller 404b. In some aspects, the controller may allocate (e.g., direct, control) power from the power communication line to the at least one smart glass unit to maintain the current tinting level of the at least one smart glass unit when the level of charge of the power storage device is fully charged and the directed tinting level for the at least one smart glass unit is a same tinting level as the current tinting level of the at least one smart glass unit.

Please note that the functional block(s) described herein are illustrated in FIG. 10 in merely one example arrangement. In other embodiments, the techniques and functionality described above may be performed using different steps in different orders or may be grouped into a different number of steps or may be performed as a single method without distinct steps.

FIG. 11 illustrates a block diagram of an example method 1100 according to some aspects of this disclosure. In some aspects, the method 1100 may be implemented using the system 100 illustrated in FIG. 1, the system 200 illustrated in FIG. 2, the system 300 illustrated in FIG. 3, the system 400 illustrated in FIG. 4, and/or the computer system 1800 illustrated in FIG. 18. One or more steps or one or more aspects of the method 1100 may be included with and/or include one or more steps or one or more aspects of the method 500 illustrated in FIG. 5, the method 600 illustrated in FIG. 6, the method 700 illustrated in FIG. 7, the method 800 illustrated in FIG. 8, the method 900 of FIG. 9, the method 1000 illustrated in FIG. 10, the method 1200 illustrated in FIG. 12, the method 1300 illustrated in FIG. 13, the method 1400 illustrated in FIG. 14, the method 1500 illustrated in FIG. 15, the method 1600 illustrated in FIG. 16, and/or the method 1700 illustrated in FIG. 17. FIG. 11, as with the other included figures, is shown for illustrative purposes and does not limit either the possible embodiments of the present invention or the claims.

In some aspects, the method 1100 may be implemented using the system 400 illustrated in FIG. 4. At step 1101, a controller may determine a level of charge of charge of a power storage device. Step 1101 may be the same as or at least similar to step 701 of FIG. 7, step 801 of FIG. 8, step 901 of FIG. 9, step 1001 of FIG. 10, step 1201 of FIG. 12, step 1301 of FIG. 13, step 1401 of FIG. 14, step 1501 of FIG. 15, step 1601 of FIG. 16, and/or step 1701 of FIG. 17 and may include one or more same or similar features described at least with respect to step 701 of FIG. 7, step 801 of FIG. 8, step 901 of FIG. 9, step 1001 of FIG. 10, step 1201 of FIG. 12, step 1301 of FIG. 13, step 1401 of FIG. 14, step 1501 of FIG. 15, step 1601 of FIG. 16, and/or step 1701 of FIG. 17.

At step 1103, the controller may identify a current tinting level of at least one smart glass unit of one or more smart glass units. Step 1103 may be the same as or at least similar to step 703 of FIG. 7, step 803 of FIG. 8, step 903 of FIG. 9, step 1003 of FIG. 10, step 1203 of FIG. 12, step 1303 of FIG. 13, step 1403 of FIG. 14, step 1503 of FIG. 15, step 1603 of FIG. 16, and/or step 1703 of FIG. 17 and may include one or more same or similar features described at least with respect to step 703 of FIG. 7, step 803 of FIG. 8, step 903 of FIG. 9, step 1003 of FIG. 10, step 1203 of FIG. 12, step 1303 of FIG. 13, step 1403 of FIG. 14, step 1503 of FIG. 15, step 1603 of FIG. 16, and/or step 1703 of FIG. 17.

At step 1105, the controller may identify a directed tinting level for the at least one smart glass unit of the one or more smart glass units. Step 1105 may be the same as or at least similar to step 705 of FIG. 7, step 805 of FIG. 8, step 905 of FIG. 9, step 1005 of FIG. 10, step 1205 of FIG. 12, step 1305 of FIG. 13, step 1405 of FIG. 14, step 1505 of FIG. 15, step 1605 of FIG. 16, and/or step 1705 of FIG. 17 and may include one or more same or similar features described at least with respect to step 705 of FIG. 7, step 805 of FIG. 8, step 905 of FIG. 9, step 1005 of FIG. 10, step 1205 of FIG. 12, step 1305 of FIG. 13, step 1405 of FIG. 14, step 1505 of FIG. 15, step 1605 of FIG. 16, and/or step 1705 of FIG. 17.

At step 1107, the controller may allocate (e.g., direct, control) power from the power communication line to the at least one smart glass unit to maintain the current tinting level of the at least one smart glass unit. In some aspects, the controller may allocate (e.g., direct, control) power from the power communication line to the at least one smart glass unit to maintain the current tinting level of the at least one smart glass unit when the level of charge of the power storage device is fully charged and the directed tinting level for the at least one smart glass unit is a same tinting level as the current tinting level of the at least one smart glass unit. For example, the first controller 404a may determine that the level of charge of the first power storage device 406a (and/or the second power storage device 406b) is fully charged. The first controller 404a may also determine a current tinting level of the first smart glass unit 408a and receive a directed tinting level for the first smart glass unit 408a. The first controller 404a may determine that the directed tinting level for the first smart glass unit 408a is the same tinting level as the current tint level of the first smart glass unit 408a. Based on determining the first power storage device 406a (and/or the second power storage device 406b) is fully charged and determining that the directed tinting level for the first smart glass unit 408a is the same as the current tint level of the first smart glass unit 408a, the first controller 404a may allocate power from the power communication line 405a of the data communication cable 405 to the first smart glass unit 408a to maintain the current level of tint of the first smart glass unit 408a. The first controller 404a may determine to allocate power from the power communication line 405a instead of the first power storage device 406a due to the lesser amount of power needed to maintain a level of tint. The power stored in the first power storage device 406a may subsequently be used when one or more smart glass units of the smart glass units 408 are to perform tint switching.

At step 1109, the controller may prevent the communication of power from the power communication line to the power storage device. For example, the first controller 404a may prevent power from communicating from the power communication line 405a to the first power storage device 406a (and/or the second power storage device 406b) when the power storage devices 406a and 406b are fully charged and may instead redirect power to the second controller 404b for power allocation by the second controller 404b.

Please note that the functional block(s) described herein are illustrated in FIG. 11 in merely one example arrangement. In other embodiments, the techniques and functionality described above may be performed using different steps in different orders or may be grouped into a different number of steps or may be performed as a single method without distinct steps.

FIG. 12 illustrates a block diagram of an example method 1200 according to some aspects of this disclosure. In some aspects, the method 1200 may be implemented using the system 100 illustrated in FIG. 1, the system 200 illustrated in FIG. 2, the system 300 illustrated in FIG. 3, the system 400 illustrated in FIG. 4, and/or the computer system 1800 illustrated in FIG. 18. One or more steps or one or more aspects of the method 1200 may be included with and/or include one or more steps or one or more aspects of the method 500 illustrated in FIG. 5, the method 600 illustrated in FIG. 6, the method 700 illustrated in FIG. 7, the method 800 illustrated in FIG. 8, the method 900 illustrated in FIG. 9, the method 1000 illustrated in FIG. 10, the method 1100 illustrated in FIG. 11, the method 1300 illustrated in FIG. 13, the method 1400 illustrated in FIG. 14, the method 1500 illustrated in FIG. 15, the method 1600 illustrated in FIG. 16, and/or the method 1700 illustrated in FIG. 17. FIG. 12, as with the other included figures, is shown for illustrative purposes and does not limit either the possible embodiments of the present invention or the claims.

In some aspects, the method 1200 may be implemented using the system 400 illustrated in FIG. 4. At step 1201, a controller may determine a level of charge of charge of a power storage device. Step 1201 may be the same as or at least similar to step 701 of FIG. 7, step 801 of FIG. 8, step 901 of FIG. 9, step 1001 of FIG. 10, step 1101 of FIG. 11, step 1301 of FIG. 13, step 1401 of FIG. 14, step 1501 of FIG. 15, step 1601 of FIG. 16, and/or step 1701 of FIG. 17 and may include one or more same or similar features described at least with respect to step 701 of FIG. 7, step 801 of FIG. 8, step 901 of FIG. 9, step 1001 of FIG. 10, step 1101 of FIG. 11, step 1301 of FIG. 13, step 1401 of FIG. 14, step 1501 of FIG. 15, step 1601 of FIG. 16, and/or step 1701 of FIG. 17.

At step 1203, the controller may identify a current tinting level of at least one smart glass unit of one or more smart glass units. Step 1203 may be the same as or at least similar to step 703 of FIG. 7, step 803 of FIG. 8, step 903 of FIG. 9, step 1003 of FIG. 10, step 1103 of FIG. 11, step 1303 of FIG. 13, step 1403 of FIG. 14, step 1503 of FIG. 15, step 1603 of FIG. 16, and/or step 1703 of FIG. 17 and may include one or more same or similar features described at least with respect to step 703 of FIG. 7, step 803 of FIG. 8, step 903 of FIG. 9, step 1003 of FIG. 10, step 1103 of FIG. 11, step 1303 of FIG. 13, step 1403 of FIG. 14, step 1503 of FIG. 15, step 1603 of FIG. 16, and/or step 1703 of FIG. 17.

At step 1205, the controller may identify a directed tinting level for the at least one smart glass unit of the one or more smart glass units. Step 1205 may be the same as or at least similar to step 705 of FIG. 7, step 805 of FIG. 8, step 905 of FIG. 9, step 1005 of FIG. 10, step 1105 of FIG. 11, step 1305 of FIG. 13, step 1405 of FIG. 14, step 1505 of FIG. 15, step 1605 of FIG. 16, and/or step 1705 of FIG. 17 and may include one or more same or similar features described at least with respect to step 705 of FIG. 7, step 805 of FIG. 8, step 905 of FIG. 9, step 1005 of FIG. 10, step 1105 of FIG. 11, step 1305 of FIG. 13, step 1405 of FIG. 14, step 1505 of FIG. 15, step 1605 of FIG. 16, and/or step 1705 of FIG. 17.

At step 1207, the controller may allocate (e.g., direct, control) all of the power from the power communication line to the at least one smart glass unit to maintain the current tinting level of the at least one smart glass unit. In some aspects, the controller may allocate (e.g., direct, control) all of the power from the power communication line to the at least one smart glass unit to maintain the current tinting level of the at least one smart glass unit when the level of charge of the power storage device is not fully charged and the directed tinting level for the at least one smart glass unit is a same tinting level as the current tinting level of the at least one smart glass unit. For example, the first controller 404a may determine that the level of charge of the first power storage device 406a (and/or the second power storage device 406b) is not fully charged. The first controller 404a may also determine a current tinting level of the first smart glass unit 408a and receive a directed tinting level for the first smart glass unit 408a. The first controller 404a may determine that the directed tinting level for the first smart glass unit 408a is the same tinting level as the current tint level of the first smart glass unit 408a. Based on determining the first power storage device 406a (and/or the second power storage device 406b) is not fully charged and determining that the directed tinting level for the first smart glass unit 408a is the same as the current tint level of the first smart glass unit 408a, the first controller 404a may determine whether power is available through the power communication line 405a. When the first controller 404a determines that power is available through the power communication line 405a to maintain the current level of tint for the first smart glass unit 408a, the first controller 406a may allocate all of the power from the power communication line 405a to the first smart glass unit 408a to maintain the level of tint of the first smart glass unit 408a at the current tinting level.

Please note that the functional block(s) described herein are illustrated in FIG. 12 in merely one example arrangement. In other embodiments, the techniques and functionality described above may be performed using different steps in different orders or may be grouped into a different number of steps or may be performed as a single method without distinct steps.

FIG. 13 illustrates a block diagram of an example method 1300 according to some aspects of this disclosure. In some aspects, the method 1300 may be implemented using the system 100 illustrated in FIG. 1, the system 200 illustrated in FIG. 2, the system 300 illustrated in FIG. 3, the system 400 illustrated in FIG. 4, and/or the computer system 1800 illustrated in FIG. 18. One or more steps or one or more aspects of the method 1300 may be included with and/or include one or more steps or one or more aspects of the method 500 illustrated in FIG. 5, the method 600 illustrated in FIG. 6, the method 700 illustrated in FIG. 7, the method 800 illustrated in FIG. 8, the method 900 illustrated in FIG. 9, the method 1000 illustrated in FIG. 10, the method 1100 illustrated in FIG. 11, the method 1200 illustrated in FIG. 12, the method 1400 illustrated in FIG. 14, the method 1500 illustrated in FIG. 15, the method 1600 illustrated in FIG. 16, and/or the method 1700 illustrated in FIG. 17. FIG. 13, as with the other included figures, is shown for illustrative purposes and does not limit either the possible embodiments of the present invention or the claims.

In some aspects, the method 1300 may be implemented using the system 400 illustrated in FIG. 4. At step 1301, a controller may determine a level of charge of charge of a power storage device. Step 1301 may be the same as or at least similar to step 701 of FIG. 7, step 801 of FIG. 8, step 901 of FIG. 9, step 1001 of FIG. 10, step 1101 of FIG. 11, step 1201 of FIG. 12, step 1401 of FIG. 14, step 1501 of FIG. 15, step 1601 of FIG. 16, and/or step 1701 of FIG. 17 and may include one or more same or similar features described at least with respect to step 701 of FIG. 7, step 801 of FIG. 8, step 901 of FIG. 9, step 1001 of FIG. 10, step 1101 of FIG. 11, step 1201 of FIG. 12, step 1401 of FIG. 14, step 1501 of FIG. 15, step 1601 of FIG. 16, and/or step 1701 of FIG. 17.

At step 1303, the controller may identify a current tinting level of at least one smart glass unit of one or more smart glass units. Step 1303 may be the same as or at least similar to step 703 of FIG. 7, step 803 of FIG. 8, step 903 of FIG. 9, step 1003 of FIG. 10, step 1103 of FIG. 11, step 1203 of FIG. 12, step 1403 of FIG. 14, step 1503 of FIG. 15, step 1603 of FIG. 16, and/or step 1703 of FIG. 17 and may include one or more same or similar features described at least with respect to step 703 of FIG. 7, step 803 of FIG. 8, step 903 of FIG. 9, step 1003 of FIG. 10, step 1103 of FIG. 11, step 1203 of FIG. 12, step 1403 of FIG. 14, step 1503 of FIG. 15, step 1603 of FIG. 16, and/or step 1703 of FIG. 17.

At step 1305, the controller may identify a directed tinting level for the at least one smart glass unit of the one or more smart glass units. Step 1305 may be the same as or at least similar to step 705 of FIG. 7, step 805 of FIG. 8, step 905 of FIG. 9, step 1005 of FIG. 10, step 1105 of FIG. 11, step 1205 of FIG. 12, step 1405 of FIG. 14, step 1505 of FIG. 15, step 1605 of FIG. 16, and/or step 1705 of FIG. 17 and may include one or more same or similar features described at least with respect to step 705 of FIG. 7, step 805 of FIG. 8, step 905 of FIG. 9, step 1005 of FIG. 10, step 1105 of FIG. 11, step 1205 of FIG. 12, step 1405 of FIG. 14, step 1505 of FIG. 15, step 1605 of FIG. 16, and/or step 1705 of FIG. 17.

At step 1307, the controller may allocate (e.g., direct, control) a portion of the power from the power communication line to the power storage device. In some aspects, the controller may allocate (e.g., direct, control) a portion of the power from the power communication line to the power storage device when the level of charge of the power storage device is no charge (or not fully charged) and the directed tinting level for the at least one smart glass unit is a same tinting level as the current tinting level of the at least one smart glass unit. For example, the first controller 404a may determine that the level of charge of the first power storage device 406a (and/or the second power storage device 406b) is no charge (or not fully charged). The first controller 404a may also determine a current tinting level of the first smart glass unit 408a and receive a directed tinting level for the first smart glass unit 408a. The first controller 404a may determine that the directed tinting level for the first smart glass unit 408a is the same tinting level as the current tint level of the first smart glass unit 408a. Based on determining the first power storage device 406a (and/or the second power storage device 406b) is no charge (or not fully charged) and determining that the directed tinting level for the first smart glass unit 408a is the same as the current tint level of the first smart glass unit 408a, the first controller 404a may determine an amount of power available through the power communication line 405a. When the first controller 404a determines that the power communication line 405a provides more than enough power to maintain the current level of tint for the first smart glass unit 408a, the first controller 404a may allocate power from the power communication line 405a to the first smart glass unit 408a to maintain the level of tint of the first smart glass unit 408a at the current tinting level and a remaining amount of power from the power communication line 405a to the first power storage device 406a (and/or the second power storage device 406b) for power storage. The first controller 404a may allocate the remaining amount of power from the power communication line 405a to the first power storage device 406a until the first controller 404a determines that the first power storage device 406a (and/or the second power storage device 406b) is fully charged.

Please note that the functional block(s) described herein are illustrated in FIG. 13 in merely one example arrangement. In other embodiments, the techniques and functionality described above may be performed using different steps in different orders or may be grouped into a different number of steps or may be performed as a single method without distinct steps.

FIG. 14 illustrates a block diagram of an example method 1400 according to some aspects of this disclosure. In some aspects, the method 1400 may be implemented using the system 100 illustrated in FIG. 1, the system 200 illustrated in FIG. 2, the system 300 illustrated in FIG. 3, the system 400 illustrated in FIG. 4, and/or the computer system 1800 illustrated in FIG. 18. One or more steps or one or more aspects of the method 1400 may be included with and/or include one or more steps or one or more aspects of the method 500 illustrated in FIG. 5, the method 600 illustrated in FIG. 6, the method 700 illustrated in FIG. 7, the method 800 illustrated in FIG. 8, the method 900 illustrated in FIG. 9, the method 1000 illustrated in FIG. 10, the method 1100 illustrated in FIG. 11, the method 1200 illustrated in FIG. 12, the method 1300 illustrated in FIG. 13, the method 1400 illustrated in FIG. 14, the method 1500 illustrated in FIG. 15, the method 1600 illustrated in FIG. 16, and/or the method 1700 illustrated in FIG. 17. FIG. 14, as with the other included figures, is shown for illustrative purposes and does not limit either the possible embodiments of the present invention or the claims.

In some aspects, the method 1400 may be implemented using the system 400 illustrated in FIG. 4. At step 1401, a controller may determine a level of charge of charge of a power storage device. Step 1401 may be the same as or at least similar to step 701 of FIG. 7, step 801 of FIG. 8, step 901 of FIG. 9, step 1001 of FIG. 10, step 1101 of FIG. 11, step 1201 of FIG. 12, step 1301 of FIG. 13, step 1501 of FIG. 15, step 1601 of FIG. 16, and/or step 1701 of FIG. 17 and may include one or more same or similar features described at least with respect to step 701 of FIG. 7, step 801 of FIG. 8, step 901 of FIG. 9, step 1001 of FIG. 10, step 1101 of FIG. 11, step 1201 of FIG. 12, step 1301 of FIG. 13, step 1401 of FIG. 14, step 1501 of FIG. 15, step 1601 of FIG. 16, and/or step 1701 of FIG. 17.

At step 1403, the controller may identify a current tinting level of at least one smart glass unit of one or more smart glass units. Step 1403 may be the same as or at least similar to step 703 of FIG. 7, step 803 of FIG. 8, step 903 of FIG. 9, step 1003 of FIG. 10, step 1103 of FIG. 11, step 1203 of FIG. 12, step 1303 of FIG. 13, step 1503 of FIG. 15, step 1603 of FIG. 16, and/or step 1703 of FIG. 17 and may include one or more same or similar features described at least with respect to step 703 of FIG. 7, step 803 of FIG. 8, step 903 of FIG. 9, step 1003 of FIG. 10, step 1103 of FIG. 11, step 1203 of FIG. 12, step 1303 of FIG. 13, step 1503 of FIG. 15, step 1603 of FIG. 16, and/or step 1703 of FIG. 17.

At step 1405, the controller may identify a directed tinting level for the at least one smart glass unit of the one or more smart glass units. Step 1405 may be the same as or at least similar to step 705 of FIG. 7, step 805 of FIG. 8, step 905 of FIG. 9, step 1005 of FIG. 10, step 1105 of FIG. 11, step 1204 of FIG. 12, step 1305 of FIG. 13, step 1405 of FIG. 14, step 1505 of FIG. 15, step 1605 of FIG. 16, and/or step 1705 of FIG. 17 and may include one or more same or similar features described at least with respect to step 705 of FIG. 7, step 805 of FIG. 8, step 905 of FIG. 9, step 1005 of FIG. 10, step 1105 of FIG. 11, step 1205 of FIG. 12, step 1305 of FIG. 13, step 1505 of FIG. 15, step 1605 of FIG. 16, and/or step 1705 of FIG. 17.

At step 1407, the controller may allocate (e.g., direct, control) power from the power communication line to the power storage device until the power storage device has enough power to increase an amount of tinting of the at least one smart glass unit from the current tinting level to the directed tinting level. In some aspects, the controller may allocate (e.g., direct, control) power from the power communication line to the power storage device until the power storage device has enough power to increase an amount of tinting of the at least one smart glass unit from the current tinting level to the directed tinting level when the level of charge of the power storage device is no charge (or not fully charged) and the directed tinting level for the at least one smart glass unit is above the current tinting level of the at least one smart glass unit. For example, the first controller 404a may determine that the level of charge of the first power storage device 406a (and/or the second power storage device 406b) is no charge (or not fully charged). The first controller 404a may also determine a current tinting level of the first smart glass unit 408a and receive a directed tinting level for the first smart glass unit 408a. The first controller 404a may determine that the directed tinting level for the first smart glass unit 408a is greater than the current tint level of the first smart glass unit 408a. Based on determining the first power storage device 406a (and/or the second power storage device 406b) is no charge (or not fully charged) and determining that the directed tinting level for the first smart glass unit 408a is greater than the current tint level of the first smart glass unit 408a, the first controller 404a may determine whether power is available through the power communication line 405a. When the first controller 404a determines that power is available through the power communication line 405a, the first controller 404a may allocate power from the power communication line 405a to the first power storage device 406a (and/or the second power storage device 406b) to charge the first power storage device 406a (and/or the second power storage device 406b). In some aspects, the first controller 404a may allocate power from the power communication line 405a to the first power storage device 406a (and/or the second power storage device 406b) until the first power storage device 406a (and/or the second power storage device 406b) has enough power to perform a tint switch of the first smart glass unit 408a. Once the first power storage device 406a (and/or the second power storage device 406b) has enough charge or power to perform a tint switch of the first smart glass unit 408a, the first controller 404a may direct the first power storage device 406a (and/or the second power storage device 406b) to provide power to the first smart glass unit 408a to change the tint level of the first smart glass unit 408a from the current tint level to the directed tint level.

At step 1409, the controller may allocate (e.g., direct, control) power from the power communication line to the at least one smart glass unit to maintain the directed tinting level of the at least smart glass unit after the power storage device increases the amount of tinting of the at least one smart glass unit to the directed tinting level. In some aspects, the controller may allocate (e.g., direct, control) power from the power communication line to the at least one smart glass unit to maintain the directed tinting level of the at least smart glass unit after the power storage device increases the amount of tinting of the at least one smart glass unit to the directed tinting level when the level of charge of the power storage device is no charge and the directed tinting level for the at least one smart glass unit is above the current tinting level of the at least one smart glass unit. For example, after the first controller 404a directs the first power storage device 406a (and/or the second power storage device 406b) to provide power to the first smart glass unit 408a to change the tint level of the first smart glass unit 408a from the current tint level to the directed tint level and after the first smart glass unit 408a reaches the directed tint level, the first controller 404a may direct or allocate power from the power communication line 405a to the first smart glass unit 408a to maintain the directed tint level.

Please note that the functional block(s) described herein are illustrated in FIG. 14 in merely one example arrangement. In other embodiments, the techniques and functionality described above may be performed using different steps in different orders or may be grouped into a different number of steps or may be performed as a single method without distinct steps.

FIG. 15 illustrates a block diagram of an example method 1500 according to some aspects of this disclosure. In some aspects, the method 1500 may be implemented using the system 100 illustrated in FIG. 1, the system 200 illustrated in FIG. 2, the system 300 illustrated in FIG. 3, the system 400 illustrated in FIG. 4, and/or the computer system 1800 illustrated in FIG. 18. One or more steps or one or more aspects of the method 1500 may be included with and/or include one or more steps or one or more aspects of the method 500 illustrated in FIG. 5, the method 600 illustrated in FIG. 6, the method 700 illustrated in FIG. 7, the method 800 illustrated in FIG. 8, the method 900 illustrated in FIG. 9, the method 1000 illustrated in FIG. 10, the method 1100 illustrated in FIG. 11, the method 1200 illustrated in FIG. 12, the method 1300 illustrated in FIG. 13, the method 1400 illustrated in FIG. 14, the method 1600 illustrated in FIG. 16, and/or the method 1700 illustrated in FIG. 17. FIG. 15, as with the other included figures, is shown for illustrative purposes and does not limit either the possible embodiments of the present invention or the claims.

In some aspects, the method 1500 may be implemented using the system 400 illustrated in FIG. 4. At step 1501, a controller may determine a level of charge of charge of a power storage device. Step 1501 may be the same as or at least similar to step 701 of FIG. 7, step 801 of FIG. 8, step 901 of FIG. 9, step 1001 of FIG. 10, step 1101 of FIG. 11, step 1201 of FIG. 12, step 1301 of FIG. 13, step 1401 of FIG. 14, step 1601 of FIG. 16, and/or step 1701 of FIG. 17 and may include one or more same or similar features described at least with respect to step 701 of FIG. 7, step 801 of FIG. 8, step 901 of FIG. 9, step 1001 of FIG. 10, step 1101 of FIG. 11, step 1201 of FIG. 12, step 1301 of FIG. 13, step 1401 of FIG. 14, step 1601 of FIG. 16, and/or step 1701 of FIG. 17.

At step 1503, the controller may identify a current tinting level of at least one smart glass unit of one or more smart glass units. Step 1503 may be the same as or at least similar to step 703 of FIG. 7, step 803 of FIG. 8, step 903 of FIG. 9, step 1003 of FIG. 10, step 1103 of FIG. 11, step 1203 of FIG. 12, step 1403 of FIG. 14, step 1403 of FIG. 14, step 1603 of FIG. 16, and/or step 1703 of FIG. 17 and may include one or more same or similar features described at least with respect to step 703 of FIG. 7, step 803 of FIG. 8, step 903 of FIG. 9, step 1003 of FIG. 10, step 1103 of FIG. 11, step 1203 of FIG. 12, step 1303 of FIG. 13, step 1403 of FIG. 14, step 1603 of FIG. 16, and/or step 1703 of FIG. 17.

At step 1505, the controller may identify a directed tinting level for the at least one smart glass unit of the one or more smart glass units. Step 1405 may be the same as or at least similar to step 705 of FIG. 7, step 805 of FIG. 8, step 905 of FIG. 9, step 1005 of FIG. 10, step 1105 of FIG. 11, step 1205 of FIG. 12, step 1305 of FIG. 13, step 1405 of FIG. 14, step 1605 of FIG. 16, and/or step 1705 of FIG. 17 and may include one or more same or similar features described at least with respect to step 705 of FIG. 7, step 805 of FIG. 8, step 905 of FIG. 9, step 1005 of FIG. 10, step 1105 of FIG. 11, step 1205 of FIG. 12, step 1305 of FIG. 13, step 1405 of FIG. 14, step 1605 of FIG. 16, and/or step 1705 of FIG. 17.

At step 1507, the controller may allocate (e.g., direct, control) at least some power from the power storage device, through the power communication line, and to at least one other electronic component in electronic communication with the data communication cable. In some aspects, the controller may allocate (e.g., direct, control) at least some power from the power storage device, through the power communication line, and to at least one other electronic component in electronic communication with the data communication cable when the level of charge of the power storage device is fully charged and the directed tinting level for the at least one smart glass unit is not above the current tinting level of the at least one smart glass unit. For example, the first controller 404a may determine that the level of charge of the first power storage device 406a (and/or the second power storage device 406b) is fully charged. The first controller 404a may also determine a current tinting level of the first smart glass unit 408a and receive a directed tinting level for the first smart glass unit 408a. The first controller 404a may determine that the directed tinting level for the first smart glass unit 408a is the same tinting level as (or not greater than) the current tint level of the first smart glass unit 408a. Based on determining the first power storage device 406a (and/or the second power storage device 406b) is fully charged and determining that the directed tinting level for the first smart glass unit 408a is the same as (or not greater than) the current tint level of the first smart glass unit 408a, the first controller 404a may allocate power from the first power storage device 406a (and/or the second power storage device 406b) through the power communication line 405a and to the second controller 404b so that the second controller 404b may allocate power to one or more smart glass units associated with the second controller 404b.

Please note that the functional block(s) described herein are illustrated in FIG. 15 in merely one example arrangement. In other embodiments, the techniques and functionality described above may be performed using different steps in different orders or may be grouped into a different number of steps or may be performed as a single method without distinct steps.

FIG. 16 illustrates a block diagram of an example method 1600 according to some aspects of this disclosure. In some aspects, the method 1600 may be implemented using the system 100 illustrated in FIG. 1, the system 200 illustrated in FIG. 2, the system 300 illustrated in FIG. 3, the system 400 illustrated in FIG. 4, and/or the computer system 1800 illustrated in FIG. 18. One or more steps or one or more aspects of the method 1600 may be included with and/or include one or more steps or one or more aspects of the method 500 illustrated in FIG. 5, the method 600 illustrated in FIG. 6, the method 700 illustrated in FIG. 7, the method 800 illustrated in FIG. 8, the method 900 illustrated in FIG. 9, the method 1000 illustrated in FIG. 10, the method 1100 illustrated in FIG. 11, the method 1200 illustrated in FIG. 12, the method 1300 illustrated in FIG. 13, the method 1400 illustrated in FIG. 14, and/or the method 1700 illustrated in FIG. 17. FIG. 16, as with the other included figures, is shown for illustrative purposes and does not limit either the possible embodiments of the present invention or the claims.

In some aspects, the method 1600 may be implemented using the system 400 illustrated in FIG. 4. At step 1601, a controller may determine a level of charge of charge of a power storage device. Step 1601 may be the same as or at least similar to step 701 of FIG. 7, step 801 of FIG. 8, step 901 of FIG. 9, step 1001 of FIG. 10, step 1101 of FIG. 11, step 1201 of FIG. 12, step 13 of FIG. 13, step 1401 of FIG. 14, step 1501 of FIG. 15, and/or step 1701 of FIG. 17 and may include one or more same or similar features described at least with respect to step 701 of FIG. 7, step 801 of FIG. 8, step 901 of FIG. 9, step 1001 of FIG. 10, step 1101 of FIG. 11, step 1201 of FIG. 12, step 1301 of FIG. 13, step 1401 of FIG. 14, step 1501 of FIG. 15, and/or step 1701 of FIG. 17.

At step 1603, the controller may identify a current tinting level of at least one smart glass unit of one or more smart glass units. Step 1603 may be the same as or at least similar to step 703 of FIG. 7, step 803 of FIG. 8, step 903 of FIG. 9, step 1003 of FIG. 10, step 1103 of FIG. 11, step 1203 of FIG. 12, step 1303 of FIG. 13, step 1403 of FIG. 14, 1503 of FIG. 15, and/or step 1703 of FIG. 17 and may include one or more same or similar features described at least with respect to step 703 of FIG. 7, step 803 of FIG. 8, step 903 of FIG. 9, step 1003 of FIG. 10, step 1103 of FIG. 11, step 1203 of FIG. 12, step 1303 of FIG. 13, step 1403 of FIG. 14, 1503 of FIG. 15, and/or step 1703 of FIG. 17.

At step 1605, the controller may identify a directed tinting level for the at least one smart glass unit of the one or more smart glass units. Step 1605 may be the same as or at least similar to step 705 of FIG. 7, step 805 of FIG. 8, step 905 of FIG. 9, step 1005 of FIG. 10, step 1105 of FIG. 11, step 1205 of FIG. 12, step 1305 of FIG. 13, step 1405 of FIG. 14, 1505 of FIG. 15, and/or step 1705 of FIG. 17 and may include one or more same or similar features described at least with respect to step 705 of FIG. 7, step 805 of FIG. 8, step 905 of FIG. 9, step 1005 of FIG. 10, step 1105 of FIG. 11, step 1205 of FIG. 12, step 1305 of FIG. 13, step 1405 of FIG. 14, 1505 of FIG. 15, and/or step 1705 of FIG. 17.

At step 1607, the controller may determine an amount of power available through at least one power communication line of a data communication cable. For example, the first controller 404a may determine an amount of power available through the power communication line 405a of the data communication cable 405 from one or more data sources (e.g., a network system, central controller, building automation system, personal computer, handheld electronic device, or the like).

At step 1609, the controller may allocate (e.g., direct, control) power from the at least one of a power communication line of a data communication cable or the power storage device and to the at least one smart glass unit of the one or more smart glass units to control a level of tint of the at least one smart glass unit. In some aspects, the controller may allocate (e.g., direct, control) power from the at least one of a power communication line of a data communication cable or the power storage device and to the at least one smart glass unit of the one or more smart glass units to control a level of tint of the at least one smart glass unit based on the level of charge of the power storage device, the current tinting level of the least one smart glass unit, the directed tinting level for the at least one smart glass unit, and the amount of power available through the at least one power communication line. For example, the first controller 404a may determine (e.g., receive an indication of) a level of charge of the first power storage device 406a (and/or the second power storage device 406b), identify (e.g., a receive an indication of) a current tinting level of first smart glass unit 408a of the smart glass units 408, identify (e.g., a receive an indication of) a directed tinting level for the first smart glass unit 408a, and determine an amount of power available through the power communication line 405a of the data communication cable 405. Based on the level of charge of the first power storage device 406a (and/or the second power storage device 406b), the current tinting level of the first smart glass unit 408a, the directed tinting level for the first smart glass unit 408, and the amount of power available through the power communication line 405a of the data communication cable 405, the first controller 404a may allocate power from at least one of the power communication line 405a or the first power storage device 406a (and/or the second power storage device 406b) and to the first smart glass unit 408a to control a level of tint of the first smart glass unit 408a.

Please note that the functional block(s) described herein are illustrated in FIG. 16 in merely one example arrangement. In other embodiments, the techniques and functionality described above may be performed using different steps in different orders or may be grouped into a different number of steps or may be performed as a single method without distinct steps.

FIG. 17 illustrates a block diagram of an example method 1700 according to some aspects of this disclosure. In some aspects, the method 1700 may be implemented using the system 100 illustrated in FIG. 1, the system 200 illustrated in FIG. 2, the system 300 illustrated in FIG. 3, the system 400 illustrated in FIG. 4, and/or the computer system 1800 illustrated in FIG. 18. One or more steps or one or more aspects of the method 1700 may be included with and/or include one or more steps or one or more aspects of the method 500 illustrated in FIG. 5, the method 600 illustrated in FIG. 6, the method 700 illustrated in FIG. 7, the method 800 illustrated in FIG. 8, the method 900 illustrated in FIG. 9, the method 1000 illustrated in FIG. 10, the method 1100 illustrated in FIG. 11, the method 1200 illustrated in FIG. 12, the method 1300 illustrated in FIG. 13, the method 1400 illustrated in FIG. 14, the method 1500 illustrated in FIG. 15, and/or the method 1600 illustrated in FIG. 16. FIG. 17, as with the other included figures, is shown for illustrative purposes and does not limit either the possible embodiments of the present invention or the claims.

In some aspects, the method 1700 may be implemented using the system 400 illustrated in FIG. 4. At step 1701, a controller may determine a level of charge of a first power storage device. For example, the first controller 404a may determine that the first power storage device 406a is not charged. Step 1701 may be the same as or at least similar to step 701 of FIG. 7, step 801 of FIG. 8, step 901 of FIG. 9, step 1001 of FIG. 10, step 1101 of FIG. 11, step 1201 of FIG. 12, step 13 of FIG. 13, step 1401 of FIG. 14, step 1501 of FIG. 15, and/or step 1601 of FIG. 16 and may include one or more same or similar features described at least with respect to step 701 of FIG. 7, step 801 of FIG. 8, step 901 of FIG. 9, step 1001 of FIG. 10, step 1101 of FIG. 11, step 1201 of FIG. 12, step 1301 of FIG. 13, step 1401 of FIG. 14, step 1501 of FIG. 15, and/or step 1601 of FIG. 16.

At step 1703, the controller may determine a level of charge of a second power storage device. For example, the first controller 404a may determine that the second power storage device 406b is at least partially charged. Step 1703 may be the same as or at least similar to step 701 of FIG. 7, step 801 of FIG. 8, step 901 of FIG. 9, step 1001 of FIG. 10, step 1101 of FIG. 11, step 1201 of FIG. 12, step 1301 of FIG. 13, step 1401 of FIG. 14, step 1501 of FIG. 15, and/or step 1601 of FIG. 16 and may include one or more same or similar features described at least with respect to step 701 of FIG. 7, step 801 of FIG. 8, step 901 of FIG. 9, step 1001 of FIG. 10, step 1101 of FIG. 11, step 1201 of FIG. 12, step 1301 of FIG. 13, step 1401 of FIG. 14, step 1501 of FIG. 15, and/or step 1601 of FIG. 16.

At step 1705, the controller may identify a current tinting level of at least one smart glass unit of one or more smart glass units. Step 1705 may be the same as or at least similar to step 703 of FIG. 7, step 803 of FIG. 8, step 903 of FIG. 9, step 1003 of FIG. 10, step 1103 of FIG. 11, step 1203 of FIG. 12, step 1303 of FIG. 13, step 1403 of FIG. 14, step 1503 of FIG. 15, and/or step 1603 of FIG. 16 and may include one or more same or similar features described at least with respect to step 703 of FIG. 7, step 803 of FIG. 8, step 903 of FIG. 9, step 1003 of FIG. 10, step 1103 of FIG. 11, step 1203 of FIG. 12, step 1303 of FIG. 13, step 1403 of FIG. 14, step 1503 of FIG. 15, and/or step 1603 of FIG. 16.

At step 1707, the controller may identify a directed tinting level for the at least one smart glass unit of the one or more smart glass units. Step 1707 may be the same as or at least similar to step 705 of FIG. 7, step 805 of FIG. 8, step 905 of FIG. 9, step 1005 of FIG. 10, step 1105 of FIG. 11, step 1205 of FIG. 12, step 1305 of FIG. 13, step 1405 of FIG. 14, step 1505 of FIG. 15, and/or step 1605 of FIG. 16 and may include one or more same or similar features described at least with respect to step 705 of FIG. 7, step 805 of FIG. 8, step 905 of FIG. 9, step 1005 of FIG. 10, step 1105 of FIG. 11, step 1205 of FIG. 12, step 1305 of FIG. 13, step 1405 of FIG. 14, step 1505 of FIG. 15, and/or step 1605 of FIG. 16.

At step 1709, the controller may allocate (e.g., direct, control) power from at least one of the power communication line, the first power storage device, or the second power storage device and to the at least one smart glass unit of the one or more of smart glass units. In some aspects, the controller may allocate (e.g., direct, control) power from at least one of the power communication line, the first power storage device, or the second power storage device and to the at least one smart glass unit of the one or more of smart glass units based on the level of charge of the first power storage device, the level of charge of the second power storage device, and the tinting level for the at least one smart glass unit. For example, the first controller 404a may determine to allocate power from the second power storage device 406b to at least one smart glass units of the smart glass units 408 to change a tint of the at least one respective smart glass unit of the smart glass units 408. The first controller 404a may determine not to allocate power from first power storage device 406a and to the at least one smart glass unit of the smart glass units due to the lack of power stored in the first power storage device 406a. The first controller 404a may also determine to allocate power from the power communication line 405a to at least one other smart glass unit of the smart glass units 408 to maintain a tint of the at least one other respective smart glass unit of the smart glass units 408. In addition, when enough power is available through the power communication line 405a, the first controller 404a may determine to allocate power from the power communication line 405a and to the first power storage device 406a to charge the first power storage device 406a.

Please note that the functional block(s) described herein are illustrated in FIG. 17 in merely one example arrangement. In other embodiments, the techniques and functionality described above may be performed using different steps in different orders or may be grouped into a different number of steps or may be performed as a single method without distinct steps.

FIG. 18 illustrates an example computer system 1800 that may be used in some embodiments. The methods, features, mechanisms, techniques and/or functionality described herein may in various embodiments be implemented by any combination of hardware and software. For example, in one embodiment, the methods may be implemented by a computer system (e.g., a computer system as in FIG. 18) that includes one or more processors executing program instructions stored on a computer-readable storage medium coupled to the processors. The program instructions may implement the methods, features, mechanisms, techniques and/or functionality described herein. The various methods as illustrated in the figures and described herein represent example embodiments of methods. The order of any method may be changed, and various elements may be added, reordered, combined, omitted, modified, etc.

FIG. 18 is a block diagram illustrating a computer system 1800 according to some aspects, as well as various other systems, components, services or devices described herein. The computer system 1800, for example, may be included in the first controller 404a and/or the second controller 404b illustrated in FIG. 4 to implement any one of or combination of the method 500 of FIG. 5, the method 600 of FIG. 6, the method 700 of FIG. 7, the method 800 of FIG. 8, the method 900 of FIG. 9, the method 1000 of FIG. 10, the method 1100 of FIG. 11, the method 1200 of FIG. 12, the method 1300 of FIG. 13, the method 1400 of FIG. 14, the method 1500 of FIG. 15, the method 1600 of FIG. 16, and/or the method 1700 of FIG. 18 as well as a combination one or more steps from any of the methods described herein. For example, computer system 1800 may implement a control unit configured to implement and/or utilize the features, methods, mechanisms and/or techniques described herein, in different embodiments. Computer system 1800 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of computing device.

Computer system 1800 includes one or more processors 1810 (any of which may include multiple cores, which may be single or multi-threaded) coupled to a system memory 1820 via an input/output (I/O) interface 1830. Computer system 1800 further includes a network interface 1840 coupled to I/O interface 1830. In various embodiments, computer system 1800 may be a uniprocessor system including one processor 1810, or a multiprocessor system including several processors 1810 (e.g., two, four, eight, or another suitable number). Processors 1810 may be any suitable processors capable of executing instructions. For example, in various embodiments, processors 1810 may be general-purpose or embedded processors implementing any of a variety of instruction set architectures (ISAs), such as the x86, PowerPC, SPARC, or MIPS ISAs, or any other suitable ISA. In multiprocessor systems, each of processors 1810 may commonly, but not necessarily, implement the same ISA. The computer system 1800 also includes one or more network communication devices (e.g., network interface 1840) for communicating with other systems and/or components over a communications network (e.g., Internet, LAN, etc.).

For example, a control unit may receive information and/or commands from one or more other devices requesting that one or more EC devices be changed to a different tint level using the systems, methods and/or techniques described herein. For instance, a user may request a tint change via a portable remote control device (e.g., a remote control), a wall mounted (e.g., hard wired) device, or an application executing on any of various types of devices (e.g., a portable phone, smart phone, tablet and/or desktop computer are just a few examples).

In the illustrated embodiment, computer system 1800 is coupled to one or more portable storage devices 1880 via device interface 1870. In various embodiments, portable storage devices 1880 may correspond to disk drives, tape drives, solid state memory, other storage devices, or any other persistent storage device. Computer system 1800 (or a distributed application or operating system operating thereon) may store instructions and/or data in portable storage devices 1880, as desired, and may retrieve the stored instruction and/or data as needed. In some embodiments, portable device(s) 1880 may store information regarding one or EC devices, such as information regarding design parameters, etc. usable by control unit 320 when changing tint levels using the techniques described herein.

Computer system 1800 includes one or more system memories 1820 that can store instructions and data accessible by processor(s) 1810. In various embodiments, system memories 1820 may be implemented using any suitable memory technology, (e.g., one or more of cache, static random-access memory (SRAM), DRAM, RDRAM, EDO RAM, DDR 10 RAM, synchronous dynamic RAM (SDRAM), Rambus RAM, EEPROM, non-volatile/Flash-type memory, or any other type of memory). System memory 1820 may contain program instructions 1825 that are executable by processor(s) 1810 to implement the methods and techniques described herein. In various embodiments, program instructions 1825 may be encoded in platform native binary, any interpreted language such as Java™ bytecode, or in any other language such as C/C++, Java™, etc., or in any combination thereof. For example, in the illustrated embodiment, program instructions 1825 include program instructions executable to implement the functionality of a control unit, a stack voltage measurement module, an ESR module, an OCV module, a supervisory control system, local controller, project database, etc., in different embodiments. In some embodiments, program instructions 1825 may implement a control unit configured to implement and/or utilize the features, methods, mechanisms and/or techniques described herein, and/or other components.

In some embodiments, program instructions 1825 may include instructions executable to implement an operating system (not shown), which may be any of various operating systems, such as UNIX, LINUX, Solaris™, MacOS™, Windows™, etc. Any or all of program instructions 1825 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 1800 via I/O interface 1830. A non-transitory computer-readable storage medium may also include any volatile or non-volatile media such as RAM (e.g., SDRAM, DDR SDRAM, RDRAM, SRAM, etc.), ROM, etc., that may be included in some embodiments of computer system 1800 as system memory 1820 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 1840.

In one embodiment, I/O interface 1830 may coordinate I/O traffic between processor 1810, system memory 1820 and any peripheral devices in the system, including through network interface 1840 or other peripheral interfaces, such as device interface 1870. In some embodiments, I/O interface 1830 may perform any necessary protocol, timing or other data transformations to convert data signals from one component (e.g., system memory 1820) into a format suitable for use by another component (e.g., processor 1810). In some embodiments, I/O interface 1830 may include support for devices attached through various types of peripheral buses, such as a variant of the Peripheral Component Interconnect (PCI) bus standard or the Universal Serial Bus (USB) standard, for example. In some embodiments, the function of I/O interface 1830 may be split into two or more separate components, such as a north bridge and a south bridge, for example. Also, in some embodiments, some or all of the functionality of I/O interface 1830, such as an interface to system memory 1820, may be incorporated directly into processor 1810.

Network interface 1840 may allow data to be exchanged between computer system 1800 and other devices attached to a network, such as other computer systems 1860. In addition, network interface 1840 may allow communication between computer system 1800 and various I/O devices and/or remote storage devices. Input/output devices may, in some embodiments, include one or more display terminals, keyboards, keypads, touchpads, scanning devices, voice or optical recognition devices, or any other devices suitable for entering or retrieving data by one or more computer systems 1800. Multiple input/output devices may be present in computer system 1800 or may be distributed on various nodes of a distributed system that includes computer system 1800. In some embodiments, similar input/output devices may be separate from computer system 1800 and may interact with one or more nodes of a distributed system that includes computer system 1800 through a wired or wireless connection, such as over network interface 1840. Network interface 1840 may commonly support one or more wireless networking protocols (e.g., Wi-Fi/IEEE 802.11, or another wireless networking standard). However, in various embodiments, network interface 1840 may support communication via any suitable wired or wireless general data networks, such as other types of Ethernet networks, for example. Additionally, network interface 1840 may support communication via telecommunications/telephony networks such as analog voice networks or digital fiber communications networks, via storage area networks such as Fibre Channel SANs, or via any other suitable type of network and/or protocol. In various embodiments, computer system 1800 may include more, fewer, or different components than those illustrated in FIG. 18 (e.g., displays, video cards, audio cards, peripheral devices, other network interfaces such as an ATM interface, an Ethernet interface, a Frame Relay interface, etc.)

The various methods as illustrated in the figures and described herein represent example embodiments of methods. The methods may be implemented manually, in software, in hardware, or in a combination thereof. The order of any method may be changed, and various elements may be added, reordered, combined, omitted, modified, etc.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed is:

1. A system for power allocation having one or more smart glass units, the system comprising:
the one or more smart glass units;
a data communication cable for transmitting power and data;
a power storage device; and
a controller configured to:
determine a level of charge of the power storage device,
identify a current tinting level of at least one smart glass unit of the one or more smart glass units,
identify a directed tinting level for the at least one smart glass unit of the one or more smart glass units, and
allocate power from at least one of the power communication line or the power storage device and to the at least one smart glass unit of the one or more smart glass units to control a level of tint of the at least one smart glass unit, wherein the controller allocates power from at least one of the power communication line or the power storage device based on the level of charge of the power storage device, the current tinting level of the least one smart glass unit, and the directed tinting level for the at least one smart glass unit.

2. The system of claim 1, wherein, when the level of charge of the power storage device is fully charged and the directed tinting level for the at least one smart glass unit is above the current tinting level of the at least one smart glass unit, the controller is configured to allocate power from the power storage device to the at least one smart glass unit to increase the level of tint of the at least one smart glass unit from the current tinting level to the directed tinting level.

3. The system of claim 2, wherein the controller is further configured to allocate power from the power communication line to at least one of the power storage device or the at least one smart glass unit of the one or more smart glass units.

4. The system of claim 1, wherein, when the level of charge of the power storage device is fully charged and the directed tinting level for the at least one smart glass unit is a same tinting level as the current tinting level of the at least one smart glass unit, the controller is configured to allocate power from the power communication line to the at least one smart glass unit to maintain the current tinting level of the at least one smart glass unit.

5. The system of claim 4, wherein the controller is further configured to prevent the communication of power from the power communication line to the power storage device.

6. The system of claim 4, wherein the controller is configured to allocate all of the power from the power communication line to the at least one smart glass unit to maintain the current tinting level of the at least one smart glass unit.

7. The system of claim 1, wherein, when the level of charge of the power storage device is not fully charged and the directed tinting level for the at least one smart glass unit is a same tinting level as the current tinting level of the at least one smart glass unit, the controller is configured to:
allocate a portion of the power from the power communication line to the power storage device, and
allocate a remaining amount of the power from the power communication line to the at least one smart glass unit to maintain the current tinting level of the at least one smart glass unit.

8. The system of claim 1, wherein, when the level of charge of the power storage device is not fully charged and the directed tinting level for the at least one smart glass unit is a same tinting level as the current tinting level of the at least one smart glass unit, the controller is configured to allocate all of the power from the power communication line to the at least one smart glass unit to maintain the current tinting level of the at least one smart glass unit.

9. The system of claim 1, wherein, when the level of charge of the power storage device is no charge and the directed tinting level for the at least one smart glass unit is a same tinting level as the current tinting level of the at least one smart glass unit, the controller is configured to allocate a portion of the power from the power communication line to the power storage device.

10. The system of claim 1, wherein, when the level of charge of the power storage device is no charge and the directed tinting level for the at least one smart glass unit is above the current tinting level of the at least one smart glass unit, the controller is configured to:
allocate power from the power communication line to the power storage device until the power storage device has enough power to increase an amount of tinting of the at least one smart glass unit from the current tinting level to the directed tinting level, and
allocate power from the power communication line to the at least one smart glass unit to maintain the directed tinting level of the at least smart glass unit after the power storage device increases the amount of tinting of the at least one smart glass unit to the directed tinting level.

11. The system of claim 1, wherein, when the level of charge of the power storage device is fully charged and the directed tinting level for the at least one smart glass unit is not above the current tinting level of the at least one smart glass unit, the controller is configured to:
allocate at least some power from the power storage device, through the power communication line, and to at least one other electronic component in electronic communication with the data communication cable.

12. The system of claim 1, further comprising a switch configured to receive power and provide the power through the power communication line.

13. The system of claim 12, wherein the switch is configured to receive alternating current (AC) power, convert the AC power to direct current (DC) power, and provide the DC power through the power communication line.

14. The system of claim 1, wherein the controller is further configured to:
determine an amount of power available through the power communication line, and
allocate power from at least one of the power communication line or the power storage device and to the at least one smart glass unit of the one or more of smart glass units based on the level of charge of the power storage device, the current tinting level of the at least one smart glass unit, the directed tinting level for the at least one smart glass, and the amount of power available through the power communication line.

15. The system of claim 14, wherein, when the level of charge of the power storage device is fully charged, the tinting level for the at least one smart glass unit is above a current tinting level of the at least one smart glass unit, and the controller determines that the amount of power available through the power communication line is sufficient to increase an amount of tinting of the at least one smart glass unit from the current tinting level to the tinting level, the controller is configured to allocate power from the power communication line to the at least one smart glass unit to increase the amount of tinting of the at least one smart glass unit from the current tinting level to the tinting level.

16. The system of claim 15, wherein the controller is further configured to prevent the power storage device from providing power to the at least one smart glass unit.

17. The system of claim 1, wherein the power storage device is a first power storage device, and wherein the controller further comprises a second power storage device.

18. The system of claim 17, wherein the controller is configured to:
determine a level of charge of the second power storage device, and
allocate power from at least one of the power communication line, the first power storage device, or the second power storage device and to the at least one smart glass unit of the one or more of smart glass units, wherein the controller allocates power from at least one of the power communication line, the first power storage device, or the second power storage device based on the level of charge of the first power storage device, the level of charge of the second power storage device, the current tinting level of the least one smart glass unit, and the directed tinting level for the at least one smart glass unit.

19. A controller for allocating power to one or more smart glass units, the controller comprising:
one or more smart glass unit electronic communication channel ports for providing power to respective smart glass units of the one or more smart glass units;
a data communication cable port for receiving a data communication cable for transmitting power and data;
a power storage device;
a memory; and
one or more processors configured to:
determine a level of charge of the power storage device,
identify a current tinting level of at least one smart glass unit of the one or more smart glass units,
identify a directed tinting level for the at least one smart glass unit of the one or more smart glass units, and
allocate power from at least one of the power communication line or the power storage device and to the at least one smart glass unit of the one or more smart glass units to control a level of tint of the at least one smart glass unit, wherein the controller allocates power from at least one of the power communication line or the power storage device based on the level of charge of the power storage device, the current tinting level of the least one smart glass unit, and the directed tinting level for the at least one smart glass unit.

20. A method performed by a controller for allocating power to one or more smart glass units, the method comprising:
determining, by the controller, a level of charge of a power storage device;
identify, by the controller, a current tinting level of at least one smart glass unit of the one or more smart glass units;
identify, by the controller, a directed tinting level for the at least one smart glass unit of the one or more smart glass units; and
allocating, by the controller, power from at least one of a data communication cable or the power storage device and to the at least one smart glass unit of the one or more smart glass units to control a level of tint of the at least one smart glass unit, wherein the data communication cable is configured to transmit both power and data, and wherein the controller allocates power from at least one of the data communication cable or the power storage device based on the level of charge of the power storage device, the current tinting level of the least one smart glass unit, and the directed tinting level for the at least one smart glass unit.
